(19) United States
(12) Patent Application Publication
(10) Pub. No.: US 2020/0346420 A1
(43) Pub. Date: Nov. 5, 2020

(54) Auxetic Structure and a Method for Manufacturing an Auxetic Structure

(71) Applicant: Technische Universität Berlin, Berlin (DE)

(72) Inventor: Jan Friedrich, Berlin (DE)

(21) Appl. No.: 16/758,981

(22) PCT Filed: Oct. 26, 2018
(86) PCT No.: PCT/EP2018/079505

§ 371 Date: Apr. 24, 2020

Related U.S. Application Data
(60) Provisional application No. 62/577,957, filed on Oct. 27, 2017.
(60) Provisional application No. 62/677,774, filed on May 30, 2018.

(51) Int. Cl. B29C 70/68; B29C 70/70; B29C 70/88; B29C 70/02; B32B 3/26; B32B 3/12; B32B 5/04; B21D 13/10

(52) U.S. Cl. CPC B29C 70/688; B29C 70/70; B29C 70/88; B21D 13/10; B32B 3/266; B32B 3/12; B32B 5/04; B29C 70/023

(57) ABSTRACT

An auxetic structure includes material elements in a pattern with openings between the material elements. The structure in a planar and/or non-planar position includes at least one local variation from a regular pattern of the material elements and/or a regular pattern of the openings, so that when spatially deformed, at least some openings in the structure are locally stretchable into polygonal openings, free-from opening and/or openings with curved parts forming a spatial, grid-shaped pattern or a grid-shaped matrix.

Auxetic structures are flat materials made to exhibit auxetic behaviors through specific incisions, allowing for negative transverse stretching. These structures can then be formed into any bi-axially curved surface. By a subsequent deformation process, the cuts expand to polygonal openings and each area containing incisions turns into a spatial, grid-shaped matrix. The complex surfaces hence easily obtained can be used in the context of architecture, machinery, devices, household appliances, medicinal application etc.

An initially planar auxetic structure can be deformed to form complex shapes. In Konakovic et al., Beyond Developable: Computational Design and Fabrication with Auxetic Materials”, SIGGRAPH '16, Technical Paper Jul. 24-28, 2016, Anaheim, Calif., several application examples are given. Here the auxetic structure is composed of a regular pattern of material elements, such as triangular tiles which have openings, such as slits or cuts between them. When deformed, the resulting pattern is also deformed, i.e. the openings under deformation take on different shapes.

As described auxetic structures are initially two-dimensional structures which can be used to produce spatial shapes. They offer an approach to answer the question of how spatial shapes, especially curved and doubly-curved shapes can be efficiently produced. Auxetic structures based on regular grids can be deformed into a wide variety of spatial shapes but with no control over the resulting shape.

However, there is a need for constructing specific 3D shapes.

Our invention introduces irregular auxetic structures to solve this problem: an auxetic structure will result in one unique 3D target shape when it includes irregular incisions, allowing for the storage of the specific information of the target shape.

Starting from a desired unique 3D target shape, a corresponding irregular structure can be generated. The specific 3D information of the target shape can be implemented onto the 2D structure through irregular incisions.

Auxetic structures with a better control of the resulting shape are required.

This is addressed by an auxetic structure with the features of claim 1 and a method of claim 12. Exemplary embodiments of the auxetic structure are described in Appendices 1, 2 and 3. The appendices form an integral part of the description and specification.

Embodiments of auxetic structures are described herein (and in the appendices) which independently of scale permit the free but controlled shaping (elastic, plastic or mechanical) of planar materials, 3D starting shapes with irregular polygonal openings to achieve precisely defined, complex and doubly-curved surfaces by means of shaping forces applied perpendicularly or tangentially to the initial material for application in but not restricted to load-bearing structures, decorative systems and fluid flow systems. It is also possible that structure has local variations from a regular pattern of the material elements in a planar position in one part and in a non-planar position in another part.

The shape, density and distribution of the irregular polygonal openings facilitate the creation of a wide range of spatial geometries in the corresponding shaped structure as well as precise manipulation of material stiffness.

The negative Poisson's ratio of these auxetic structures can be manipulated by the pattern (definition, density and distribution) of the polygonal openings in the initially planar material both locally (per polygon) and globally (for the whole structure) which in turn facilitates precise control of the corresponding shaped structure. So it is the specific type of incisions that allows for the auxetic behavior (i.e. the negative Poisson's ratio) and at the same time controls the amount of deformation or the maximal possible deformation. It is this property of the auxetic structure that allows it to transform into a spatially curved shape with both a positive or negative Gaussian curvature.

On the other hand, it is also possible to account for the topological, topographical and material-specific information of the target structure (3D) through the variation of incisions patterns of the auxetic structure (2D).

So, in order to control the extent of the openings of the shaped structure, the incisions in the 2D structure need to be varied locally. This allows to steer the local deformation, giving precise control over the distribution and type of openings on the 3D target shape. There is one particular case where all the openings on the 3D shape are fully stretched (see FIG. B). In this case only, it is possible to determine one precise and specific target shape and only one.

In FIG. A a top view of an auxetic structure is shown comprising regular triangles as material elements each being connected to its neighbor according to a specific pattern. At the edges of the triangular elements, openings in the shape of incision or cuts are formed. The openings have essentially a star-shape. The overall pattern of the material elements and the openings is regular, i.e. the density of openings and material elements is the same throughout the structure. Auxetic structures like in FIG. A have been investigated by Grima 2006, 2008).

FIG. B shows an embodiment of the invention which differs from this known, regular auxetic structure shown in FIG. A. FIG. B shows an essentially planar structure with triangular material elements being connected to its neighbors according to the same specific patterns as in FIG. A but with openings between the material elements, wherein the structure comprises at least one local variation from a regular pattern (such e.g. as shown in FIG. A) of the material elements and/or the incisions.

In FIG. B, the openings vary from star-shaped, to triangular, to polygonal. It should be noted that all openings as well as all material elements have varying side lengths. This is an example of an “irregular” auxetic structure.

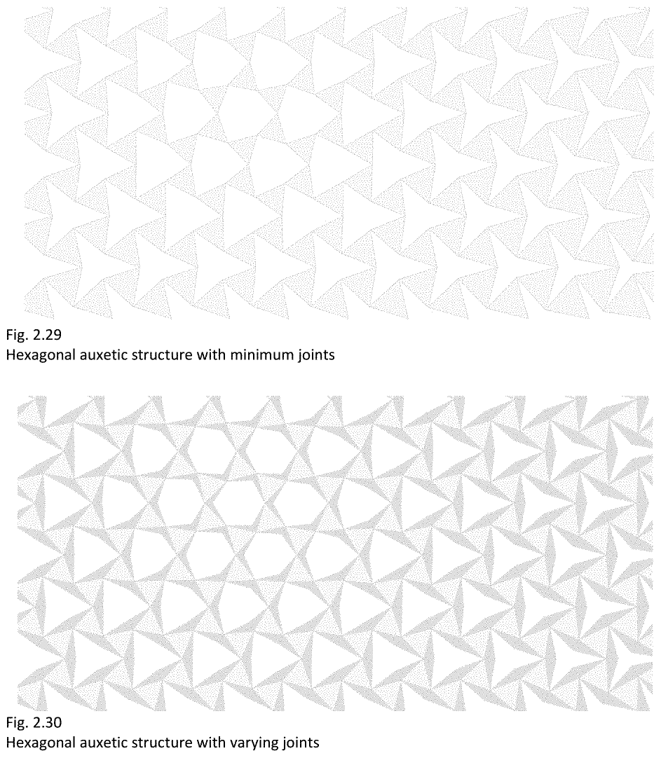

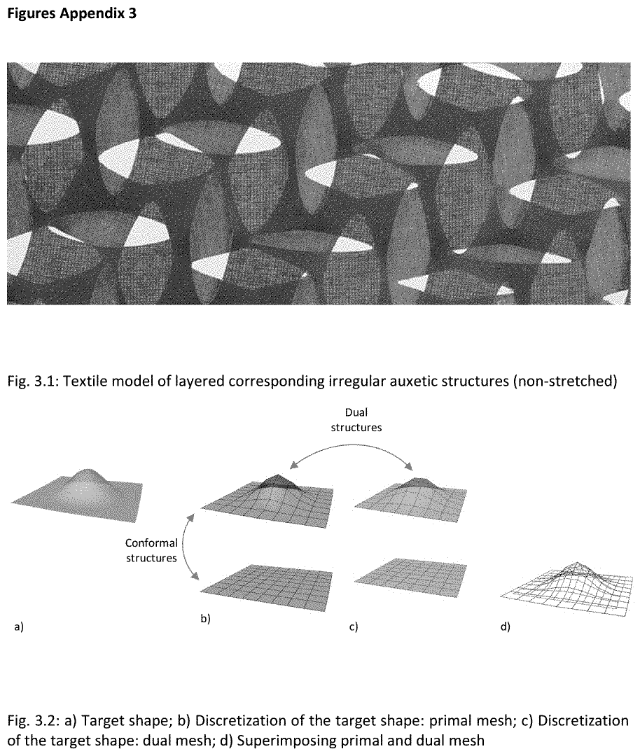

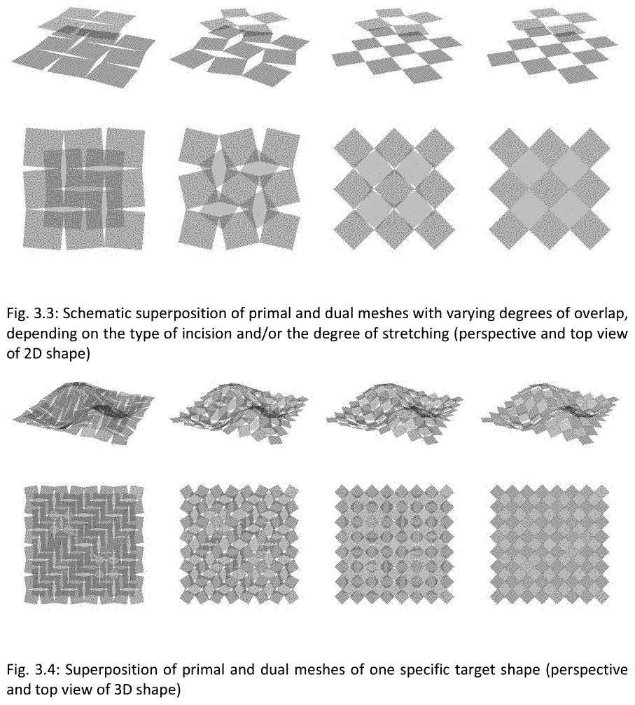

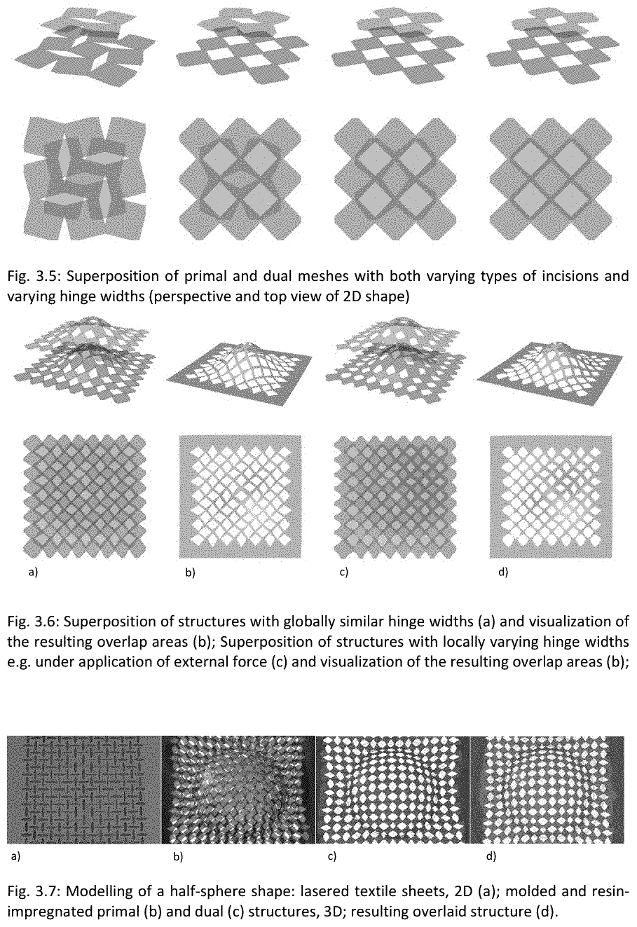

In the particular case where the planar auxetic structure (FIG. B) is fully stretched, all incisions turn into polygonal openings, creating a specific spatial structure. This is shown in FIG. C. Throughout the structure the openings have a hexagonal shape which is the maximum shape for an auxetic structure with triangular material elements (i.e. tiles), as can be seen in FIG. 3 of Appendix 1.

The dark areas in FIG. B represent the areas which are most stretchable, since the openings are relatively small compared to the lighter areas. The lighter areas in FIG. B correspond to the areas in FIG. C which are less deformed but moved most (valleys, peaks).

By introducing a local variation in the planar (or essentially planar) structure (FIG. B), i.e. by introducing an irregular pattern, a regular pattern in the stretched structure (FIG. C) can be achieved. In the fully-stretched structure, when all individual facets are maximally stretched, the auxetic structure results in one specific spatial shape.

In this way, it is possible to determine the 2D auxetic structure corresponding to our exact target shape. In addition to the topological and topographical information, material-specific information of the target shape can be “stored” in the 2D structure (see FIGS. 11 and 13 in Appendix 1).

FIG. D shows a 3D shaped auxetic structure with a positive Gaussian curvature.

FIG. E shows a 3D shaped auxetic structure with a negative Gaussian curvature.

FIG. F and G show a tessellation with a 14×14 grid. FIG. F shows the planar structure, FIG. G shows the deformed structure.

FIG. H and I show a tessellation with a 28×28 grid. FIG. H shows the planar structure, FIG. I shows the deformed structure.

FIG. J shows a planar structure where the connections between the material elements have variable dimensions. In the middle they are stronger than towards the edges of the planar structure. The more massive the connections are, the more resistance against deformation is present.

FIG. K shows a planar structure with an auxetic structure embedded in the middle, i.e. the surrounding border (i.e. un-cut, and therefore non-auxetic material) and the auxetic structure in the middle are made of the same material.

FIG. L shows a planar structure with a free-form border, i.e. the auxetic structure extends to the border.

FIG. M shows an auxetic structure based on a triangular grid with additional folds in its fully stretched target shape.

FIG. N shows an auxetic structure based on a triangular grid with additional creased allowing for bending in its fully stretched target shape.

As e.g. discussed in connection with Appendix 1, Appendix 2 and Appendix 3 auxetic structures according to the invention have advantages in several technical areas, e.g. civil engineering or machine parts.

### 1. Linkages of Auxetic Structures

The invention refers in embodiments to irregular auxetic structures either composed of a continuous surface by cutting out incisions from a flat material, or discrete elements linked by mechanical joints.

### 1.1 Continuous Surface

### 1.1.1 Joint Types-Linkages

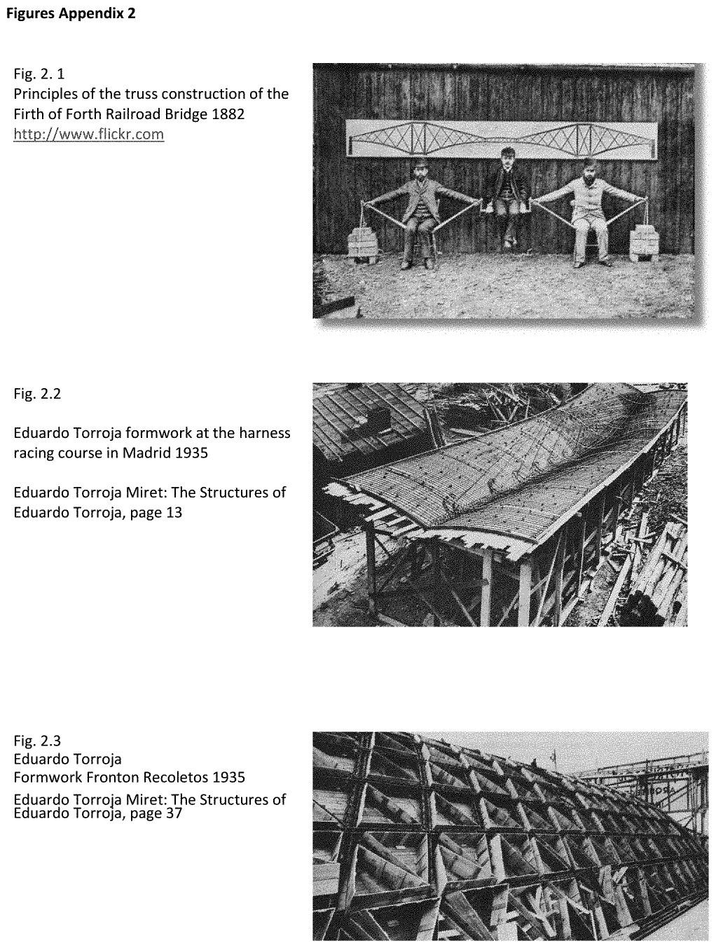

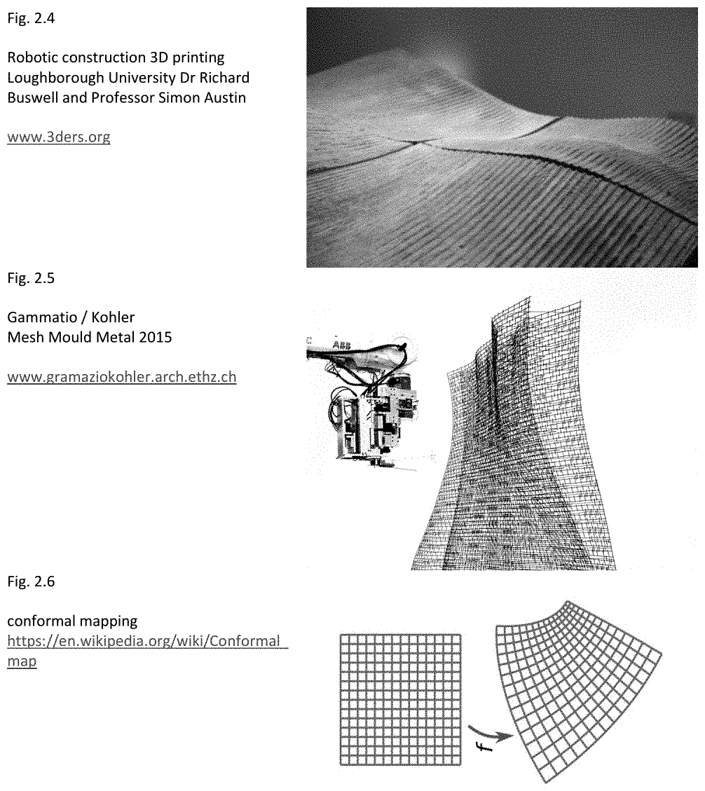

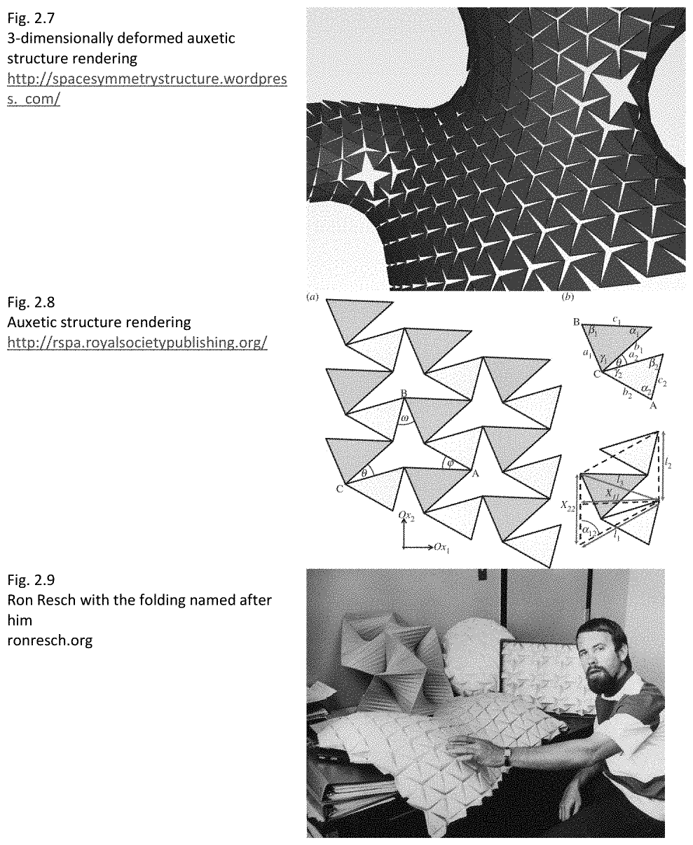

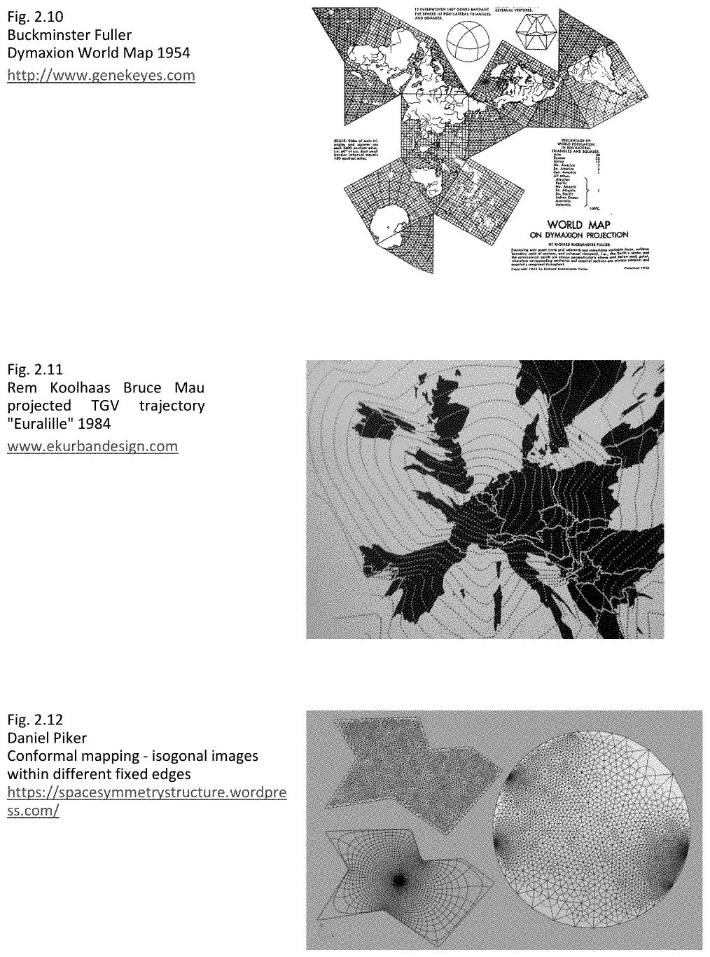

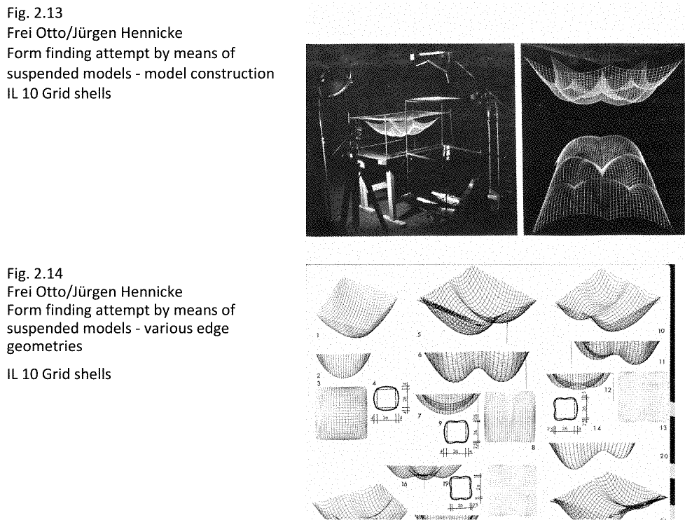

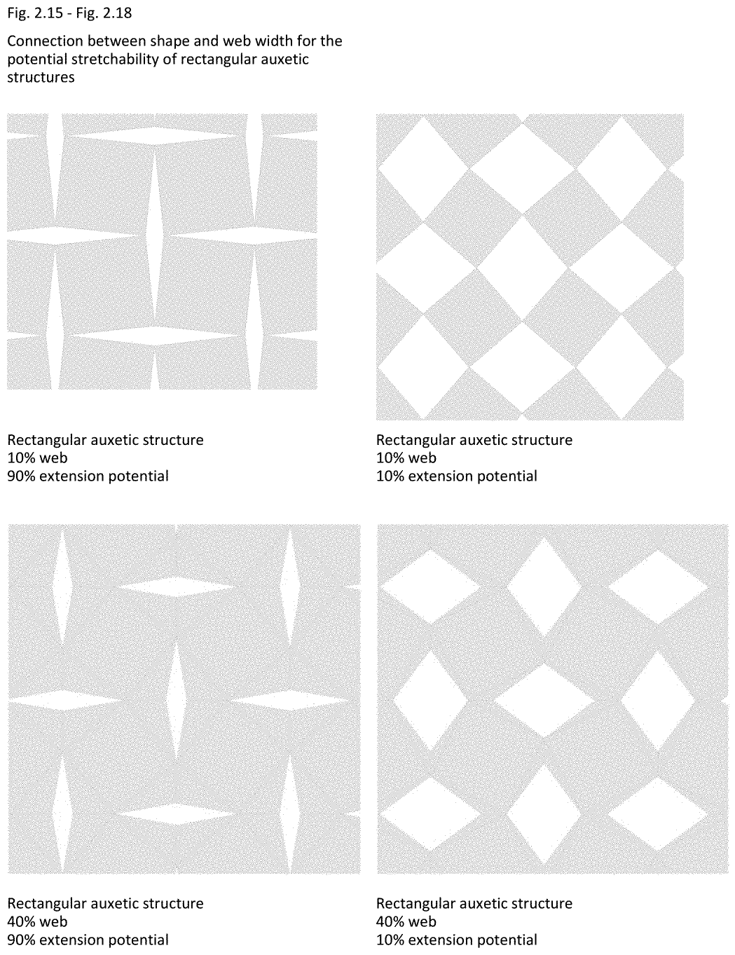

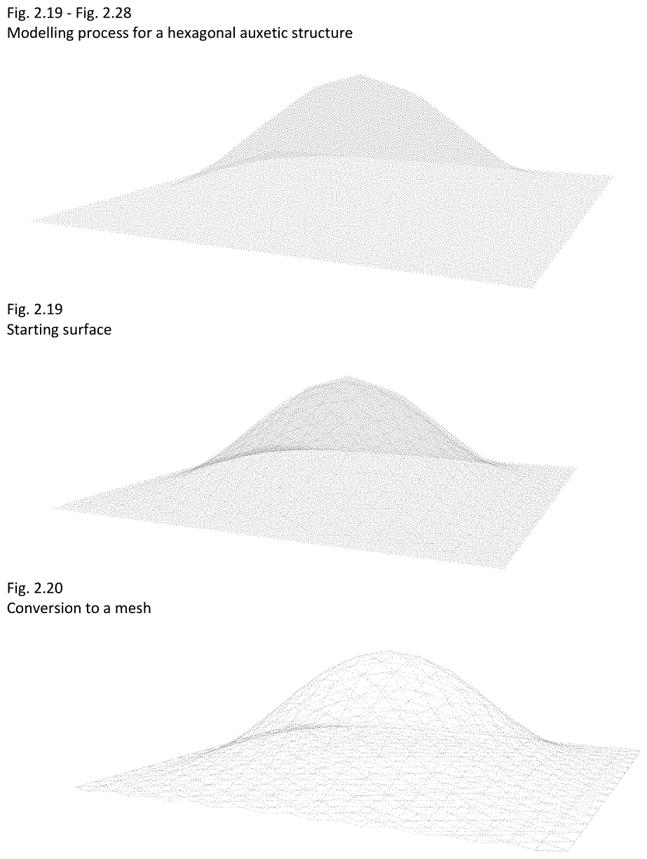

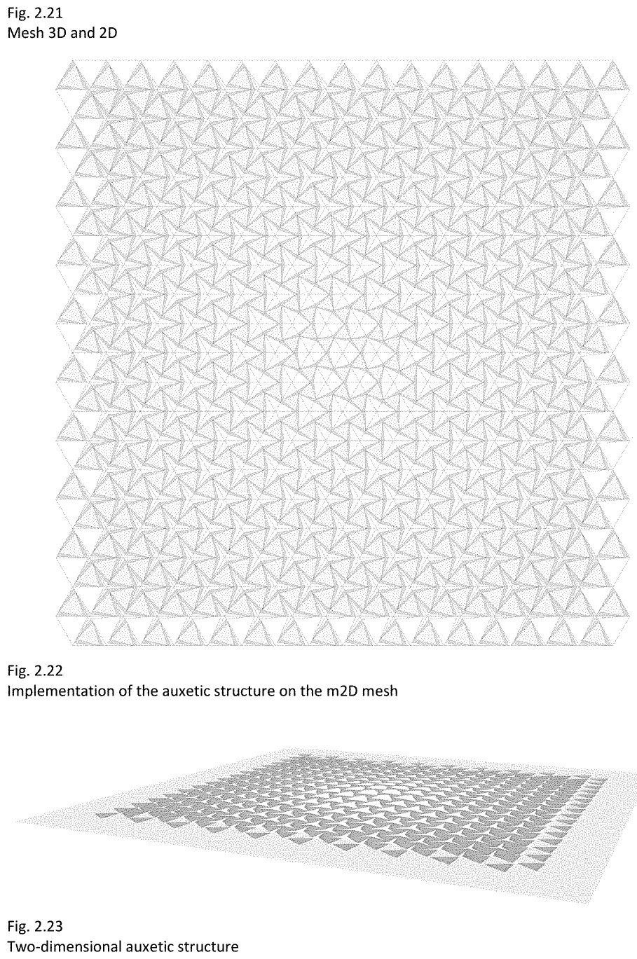

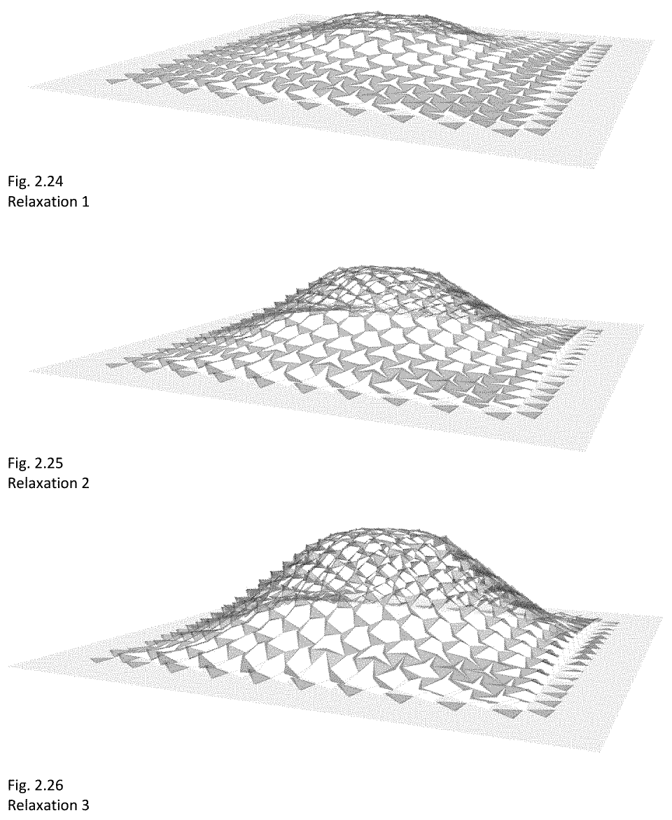

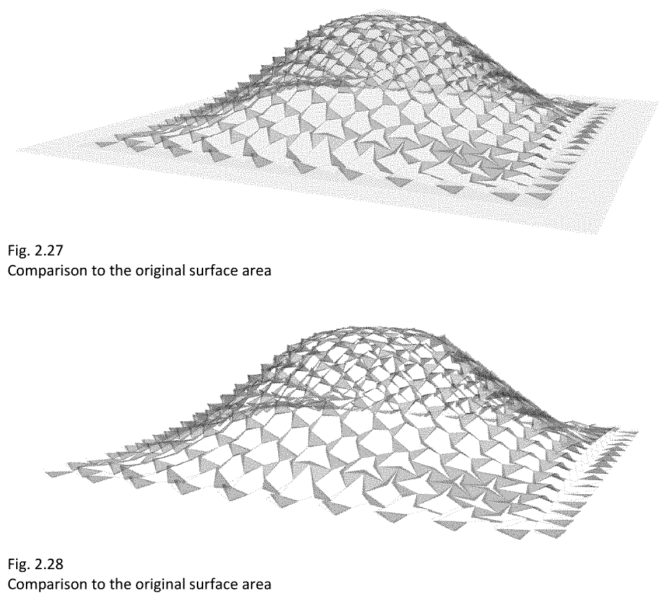

The joints can be designed as point nodes (FIGS. 2b-d; 7d), folding node (FIGS. 3a-d; 7c) or bending node (FIGS. 4a-d; 5a).

The point node describes the pure geometry: the connection point (pivot point) between two material elements (FIGS. 3a-d; 7c).

Folds: The connection between material elements has a specific width (programmable for each connection). Folding edges are added to the material elements. The kinematic movement is now a folding process.

Living hinges (flexure bearing): Further folding edges allow for bending of the material at each joint (FIGS. 4a-d; 5a-d). The kinematic movement is now a bending process.

### 1.1.2 Hinge Widths (Variable and Programmable)

The width of each hinge can be designed/programmed individually for the sake of design, structural performance etc. They can be designed with regards to the starting shape (2D or 3D) (FIGS. 20a-c) or the target shape (3D)(FIGS. 16a,b; 17a,b).

### 1.1.3 Interplay Between Hinges and Incision Patterns

Irregular auxetic structures can serve to store data. At least three different levels of information can be encoded into each single tile by varying the incisions, changing the widths of the hinges and the geometry of the hinges.

Both hinge width and incision patterns can be used for encoding different information/parameters. (2D or 3D, staring or target shape). (FIGS. 20a-c)

### 1.2 Discrete Elements

The material elements can be discrete elements being connected by point nodes (FIGS. 2a-d; 7b; 17a-c; 18a-c). This system (linkage) of elements and joints acts as a reversible expandable kinematic structure.

The hinge points can for instance be linear elements connecting neighbouring edges of the material elements. There also can be a programmable overlay of the single material element. The material elements can be connected by pivots (FIGS. 16a,b; 17a,b).

### 2. Auxetic Structure as Kinematic Linkage

### 2.1 Reversible Movement

The irregular auxetic structure can serve as kinematic structure with movement between two stable states (starting shape, retracted/target shape, fully expanded) (FIGS. 18a-c; 19a-c).

This kinematic movement can be caused e.g. by inflating or actuators.

The amount of displacement of the elements caused by the kinematic movement can be directly controlled by manipulating form and size of the incisions.

In case of pivot joints or origami folds the movement from starting geometry to the target geometry is reversible.

### 2.2 Plastic Deformability

In case of continuous plastic material elements the movement from starting geometry to the target geometry is a non-reversible bending process.

### 3. Shape of Openings

The topology and topography of the hinges are solely responsible for the stretchability of the structure. Hence the shape of the incisions and of the material elements is irrelevant to the movement and can be adapted as desired (FIGS. 5a-d). As long as the connectivity at the joints/the topography of the structure stays constant, every single incision and material element can be modulated, resulting in the same fully stretched target shape.

The derived openings can be polygonal, curved or freeform shaped (6a-d).

### 4. Basic Grid Structures

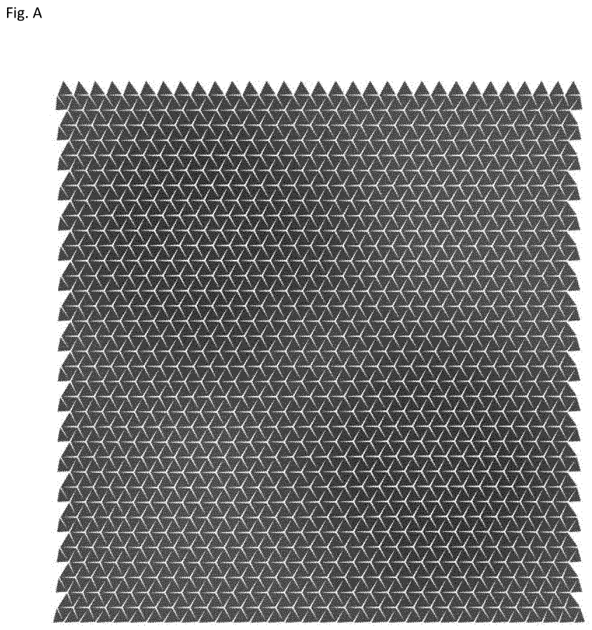

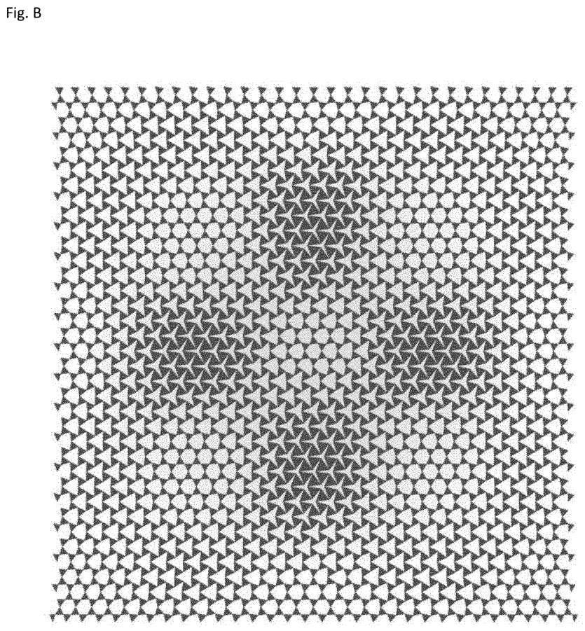

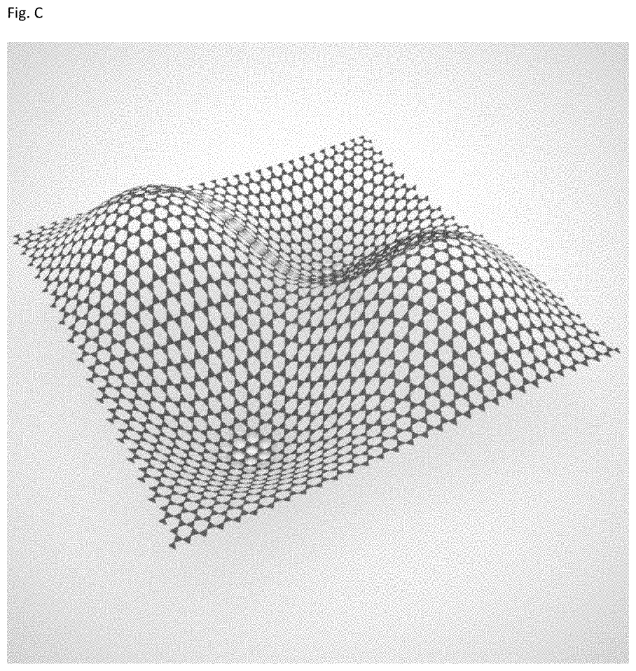

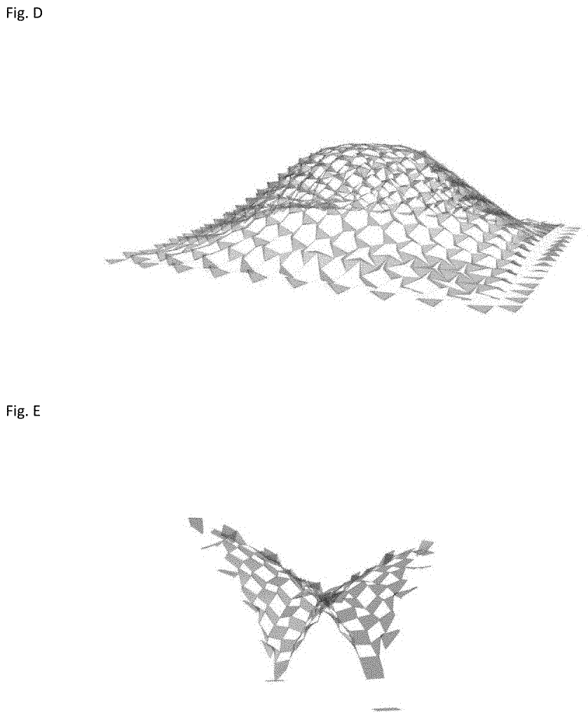

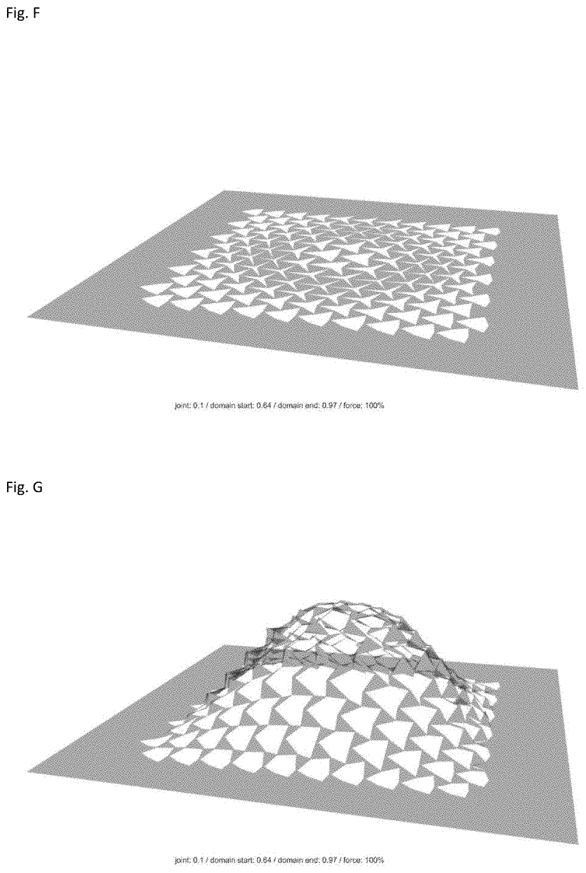

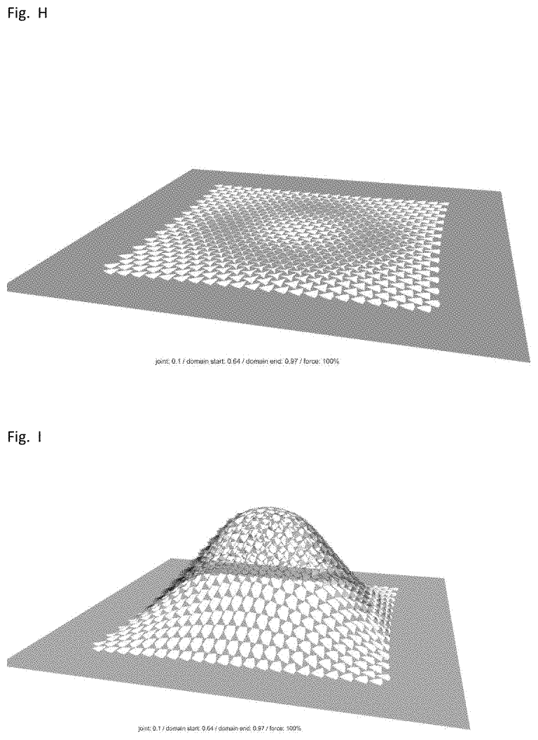

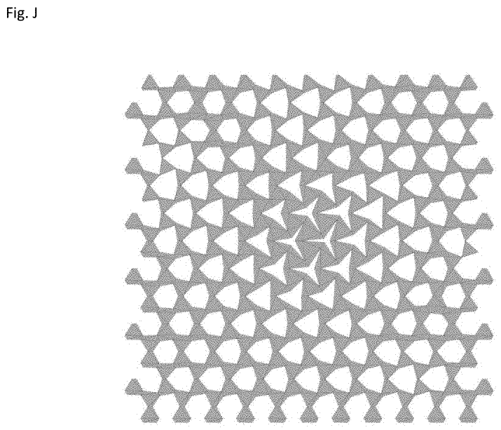

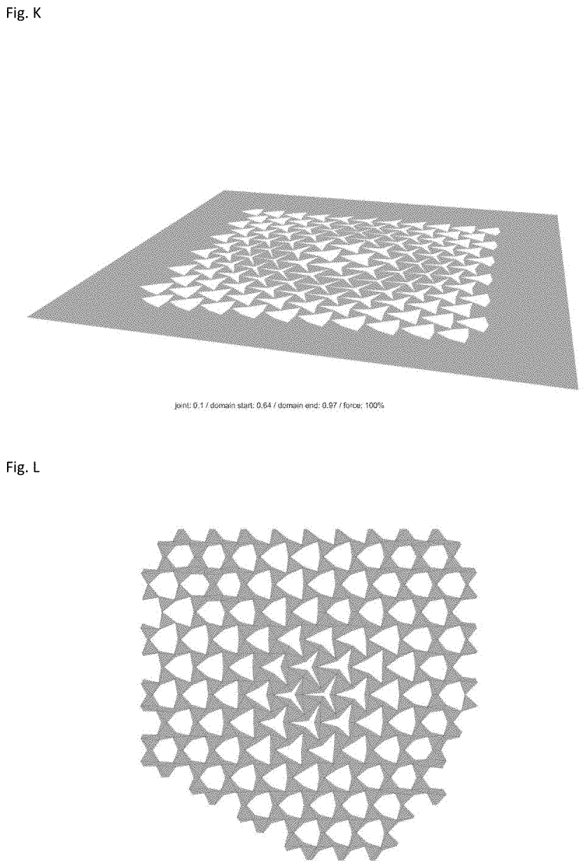

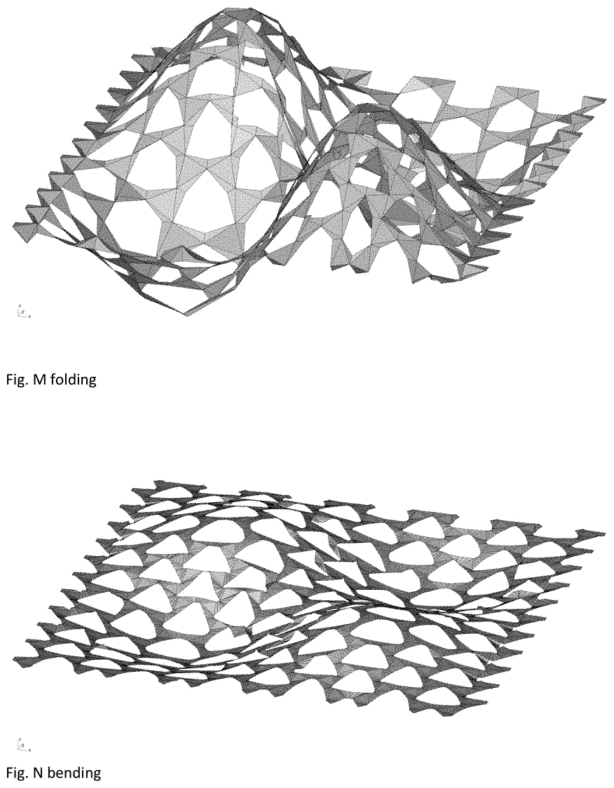

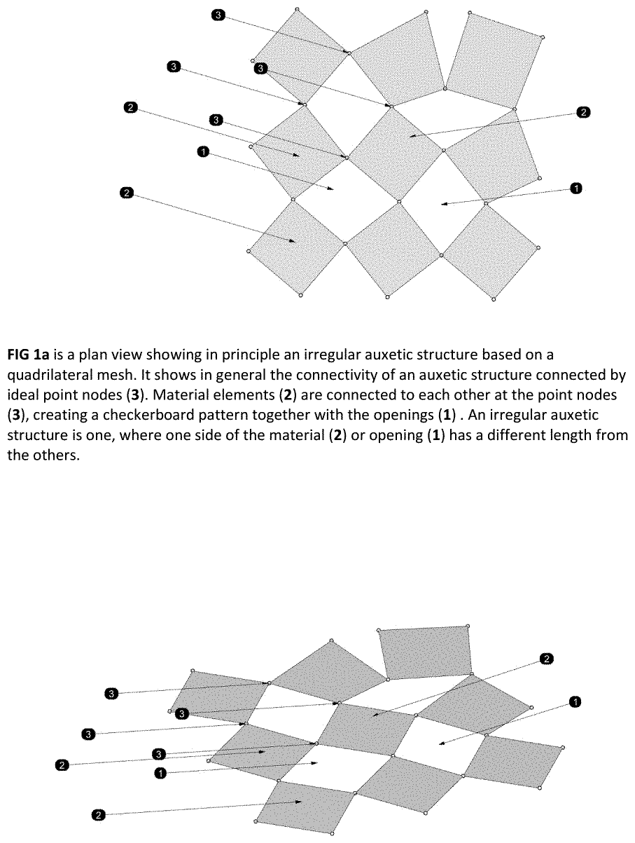

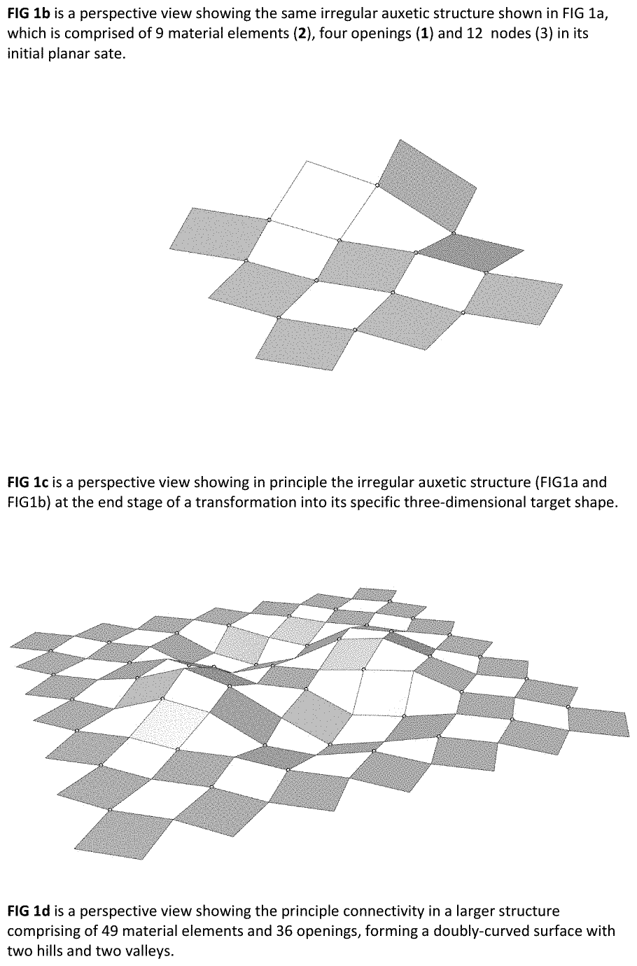

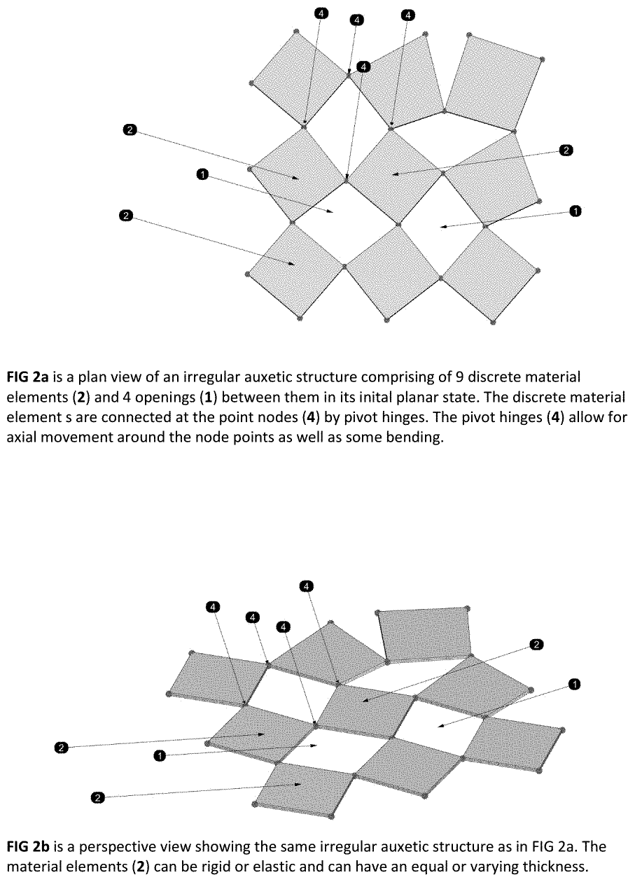

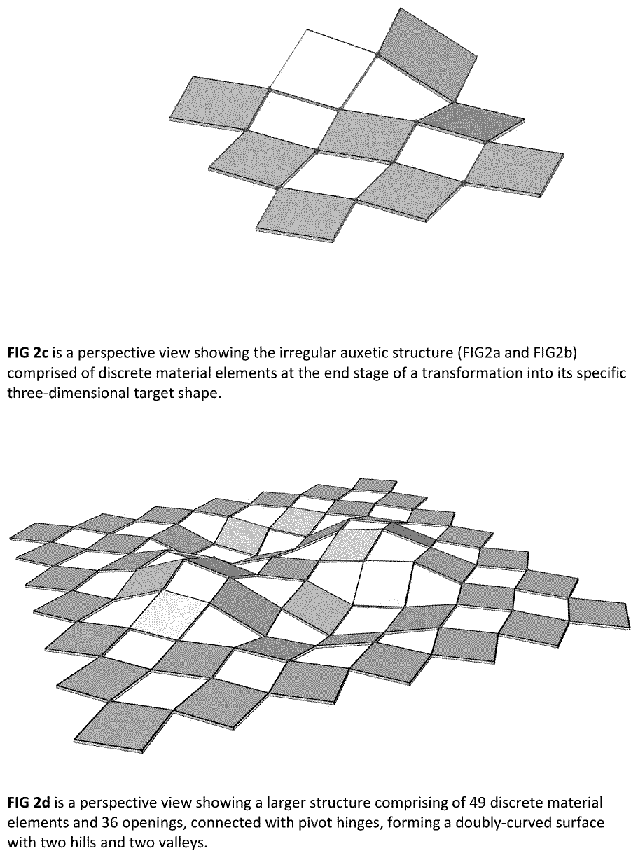

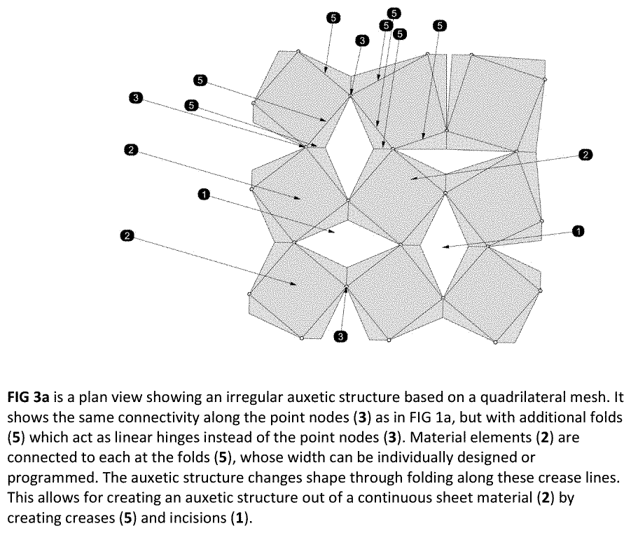

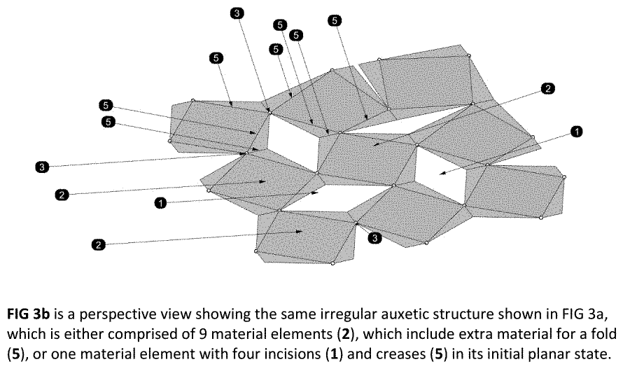

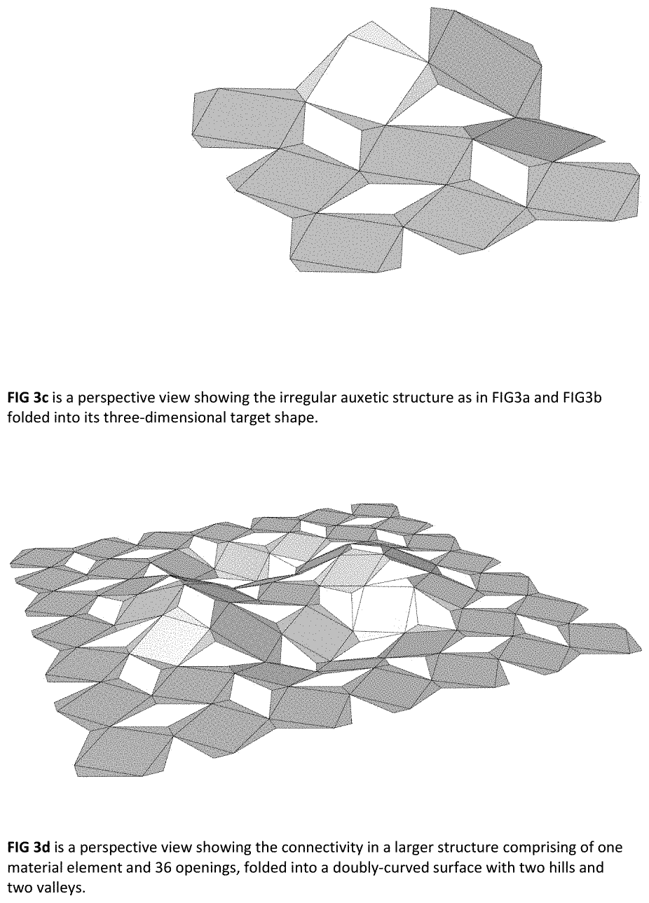

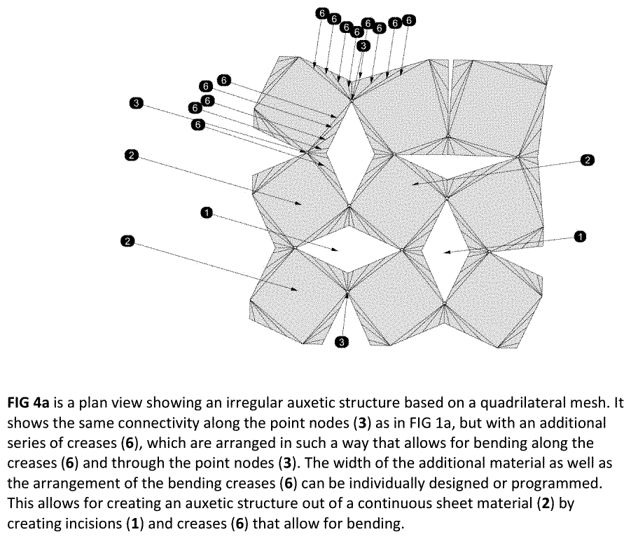

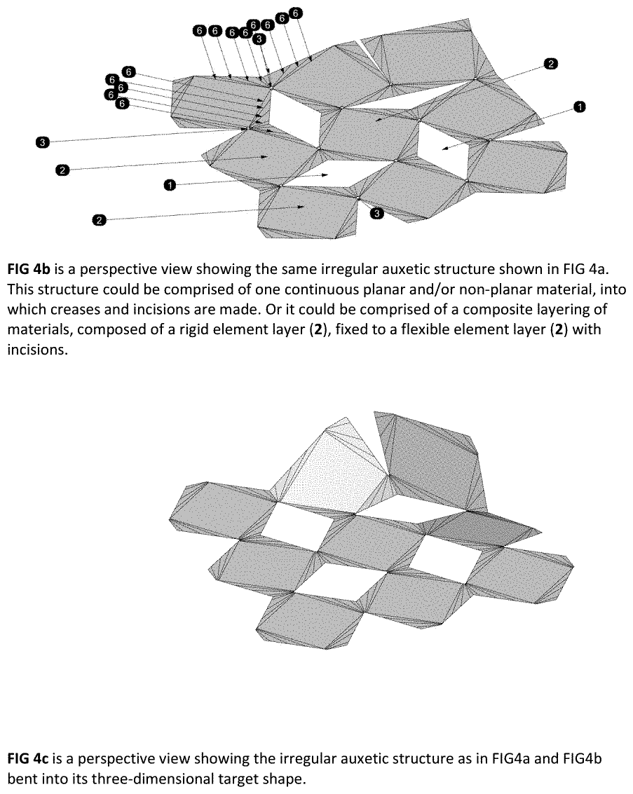

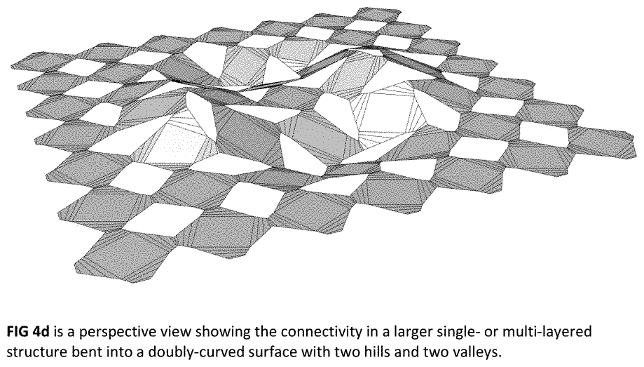

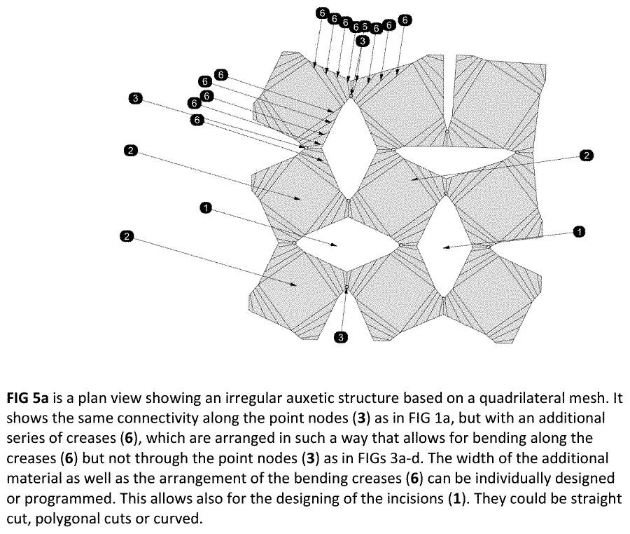

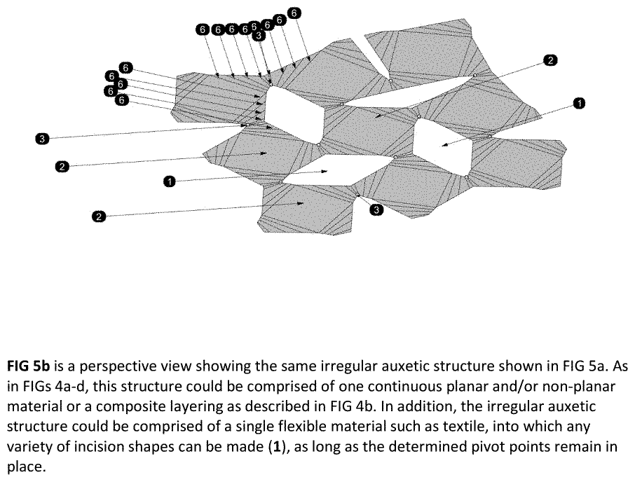

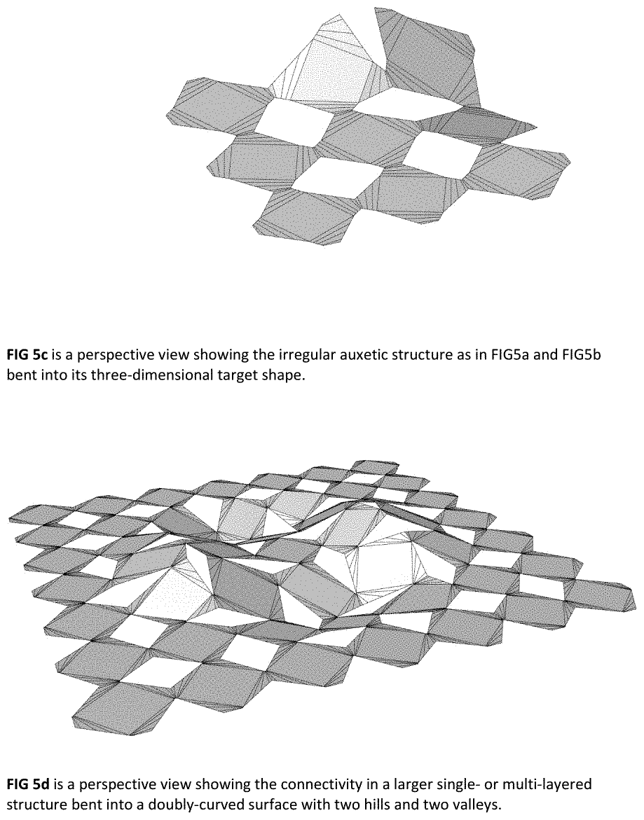

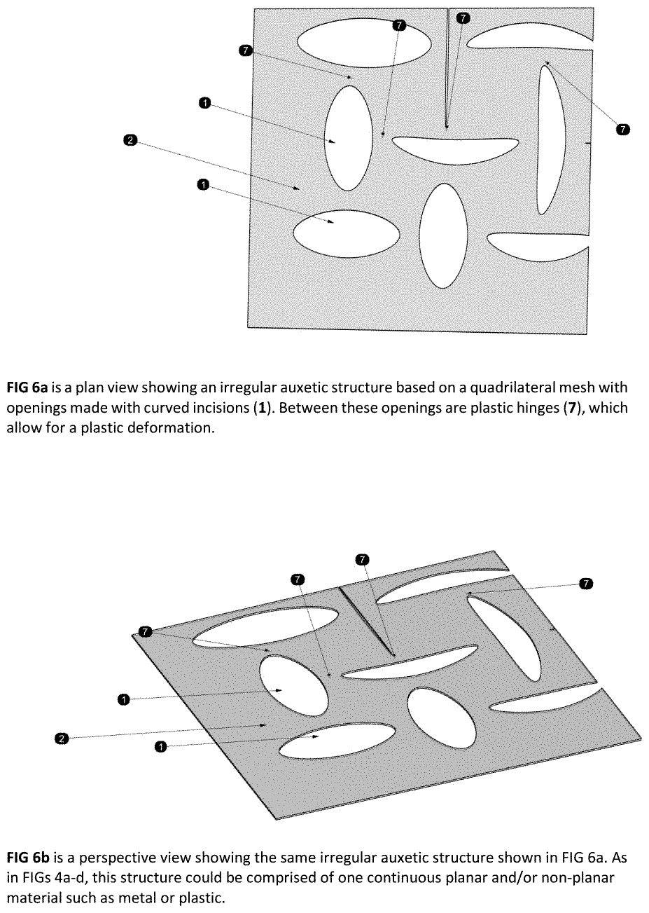

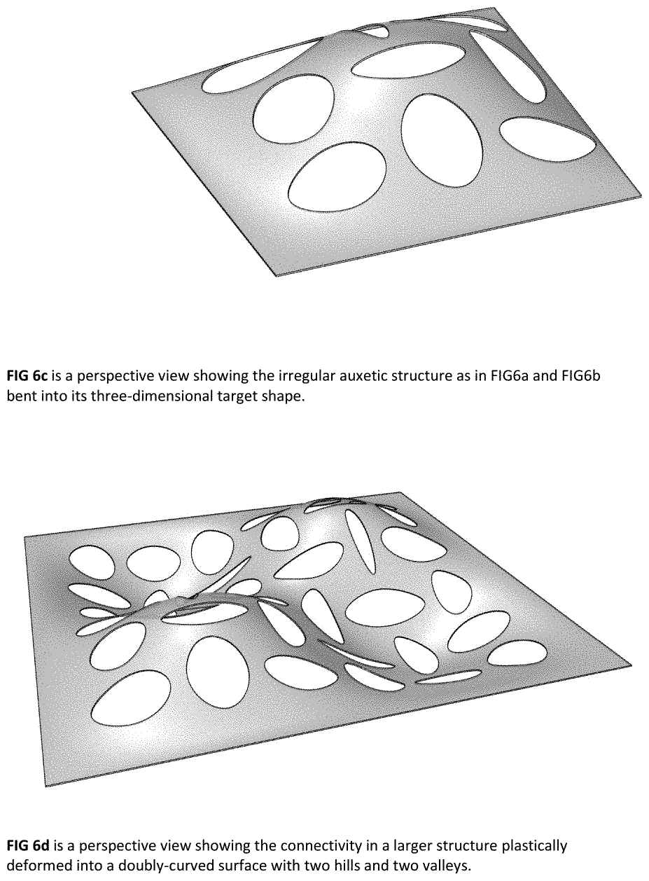

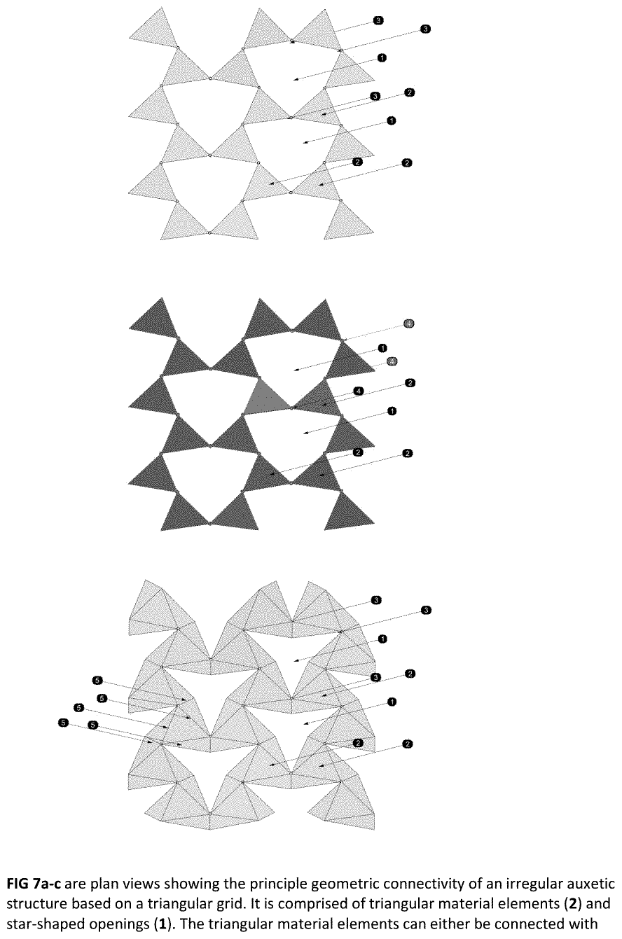

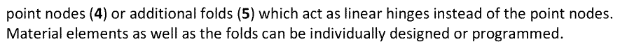

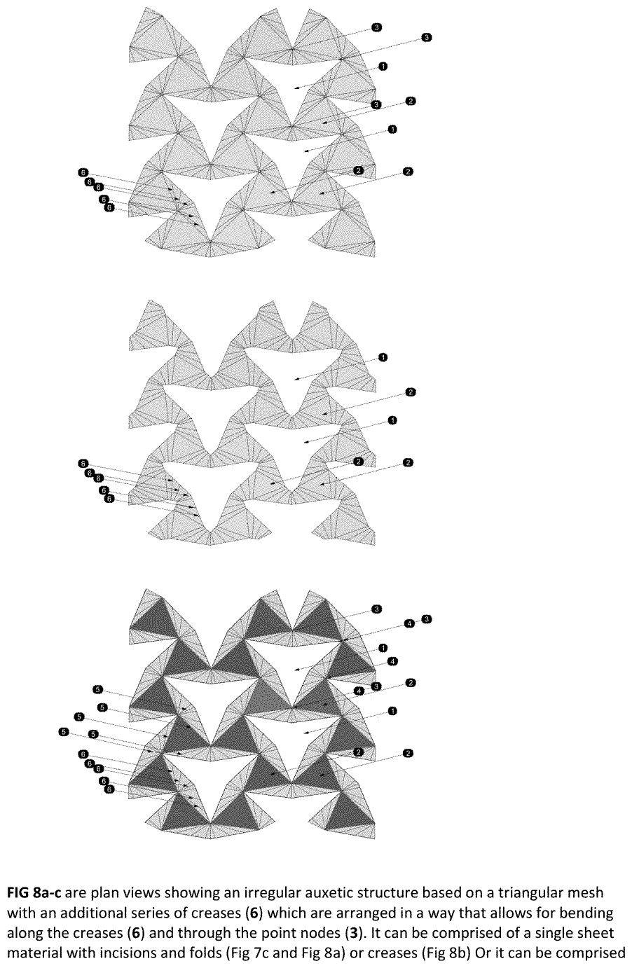

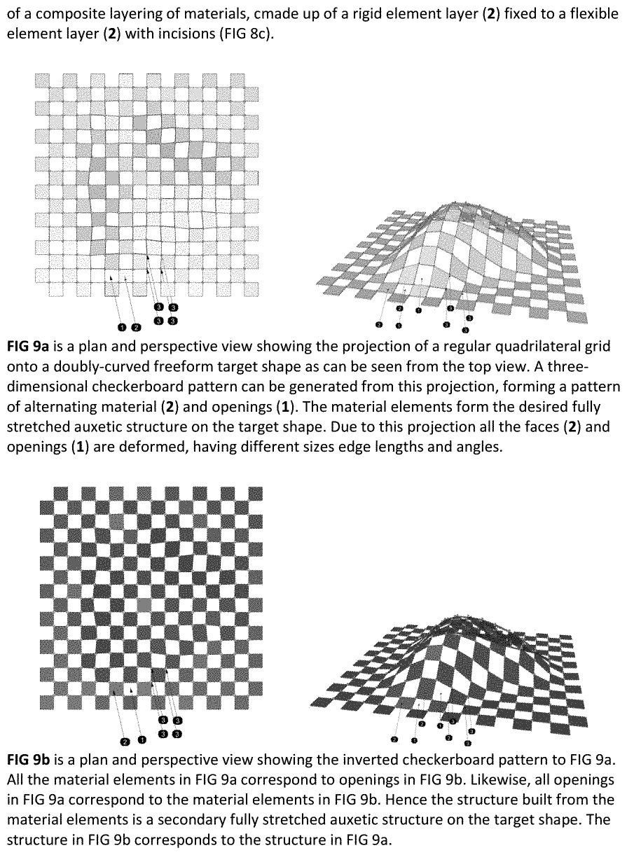

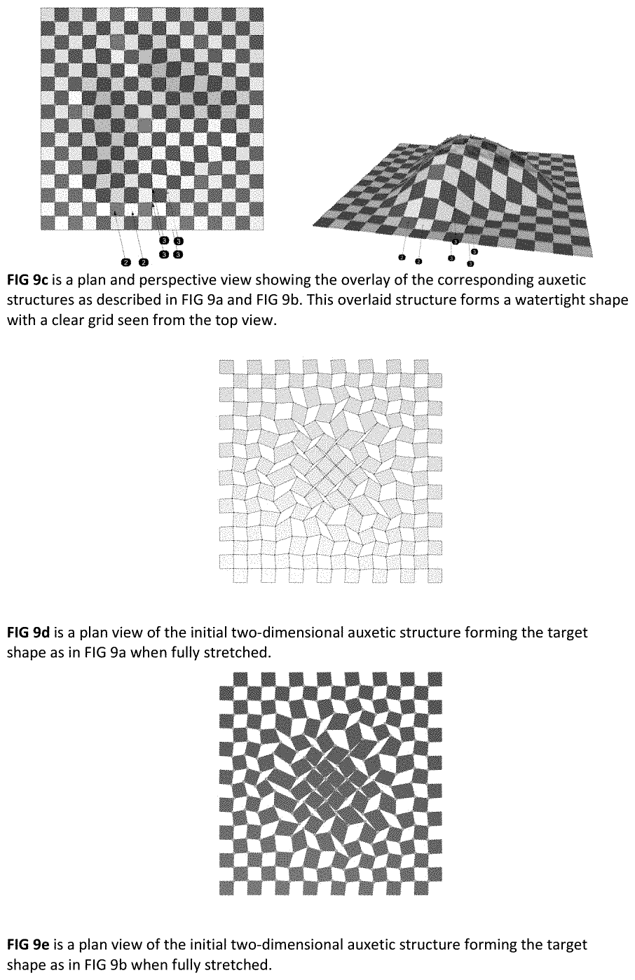

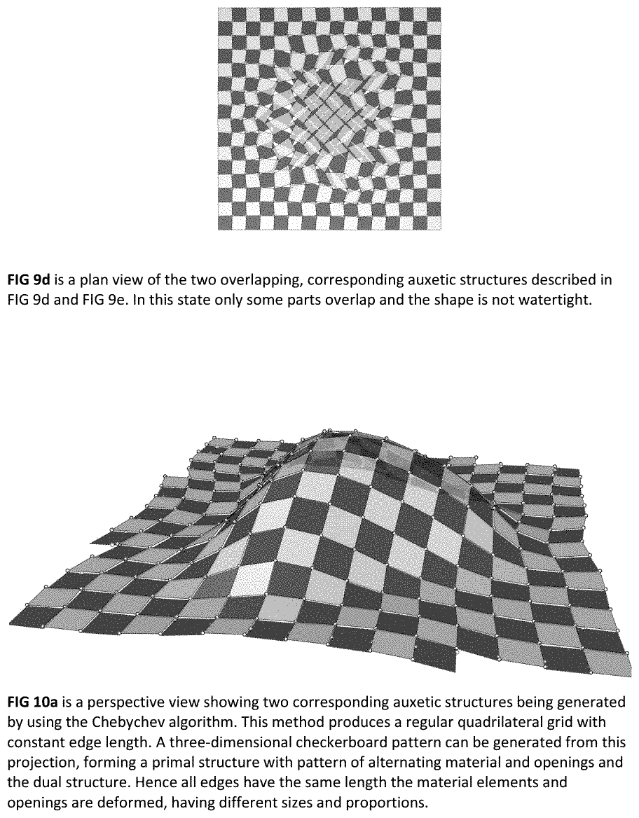

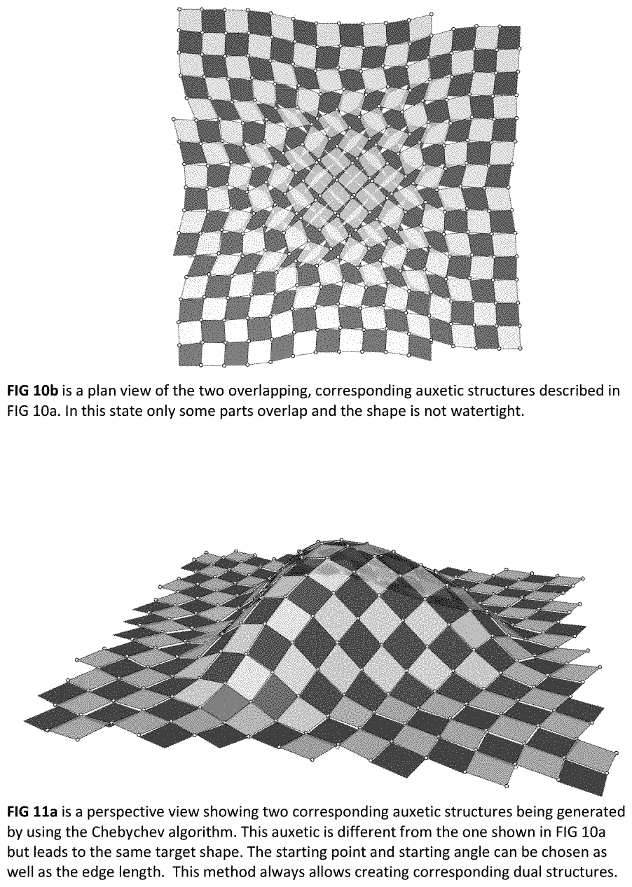

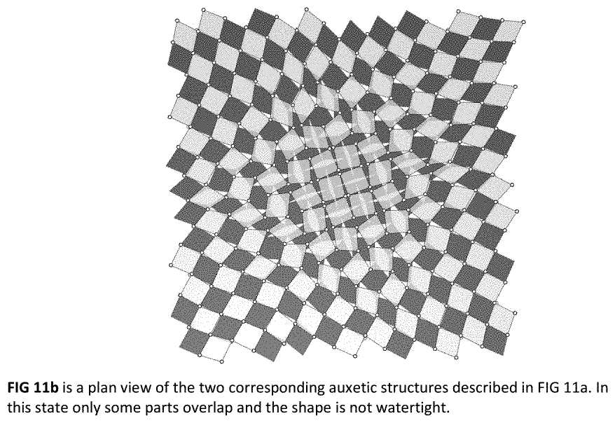

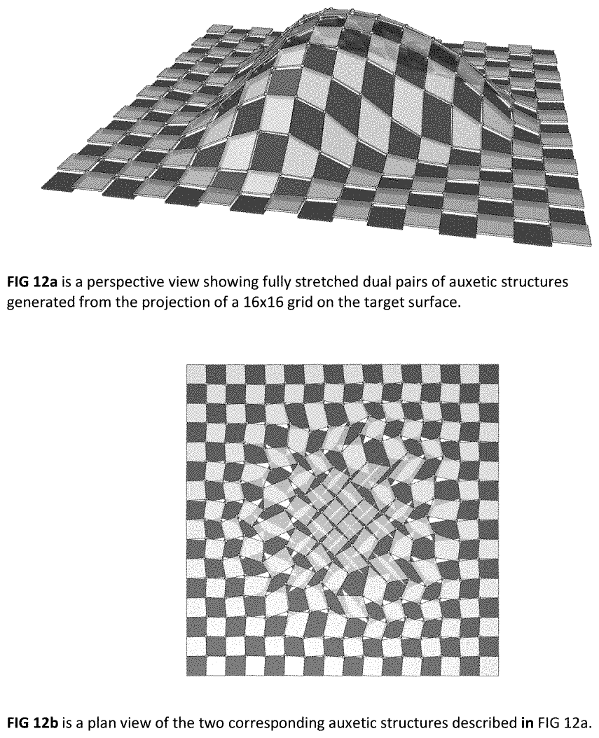

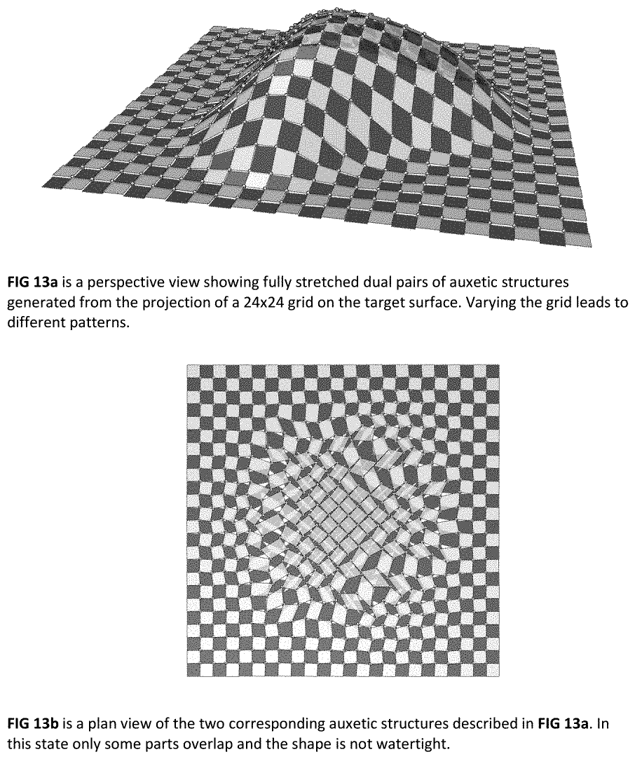

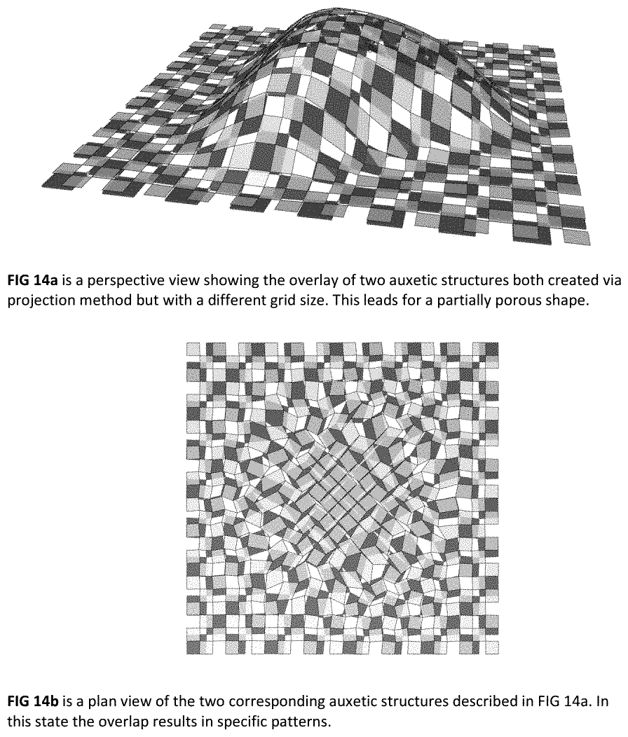

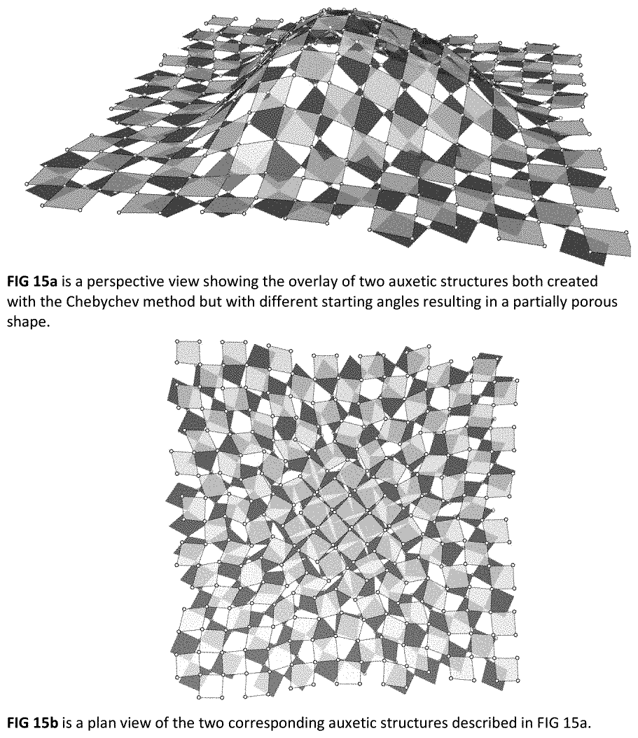

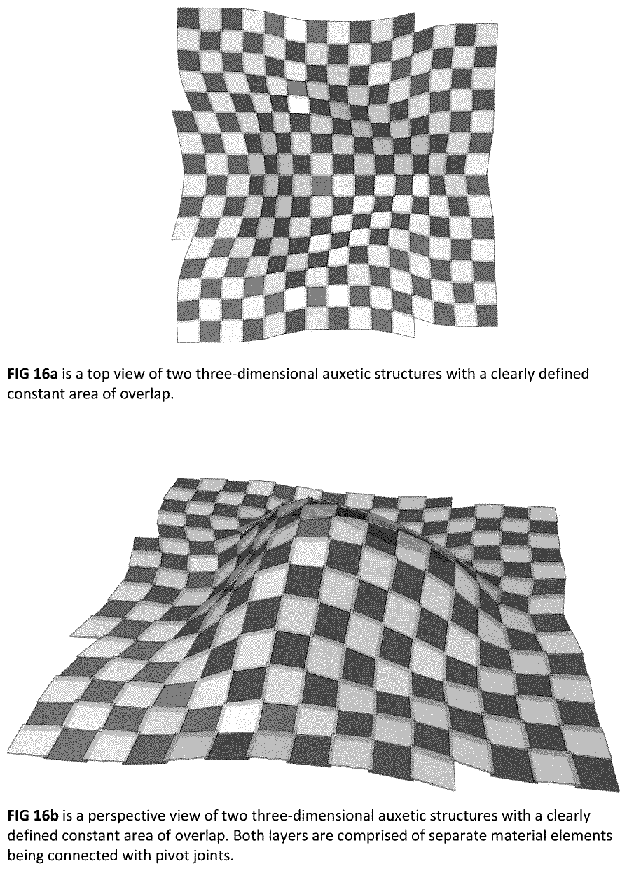

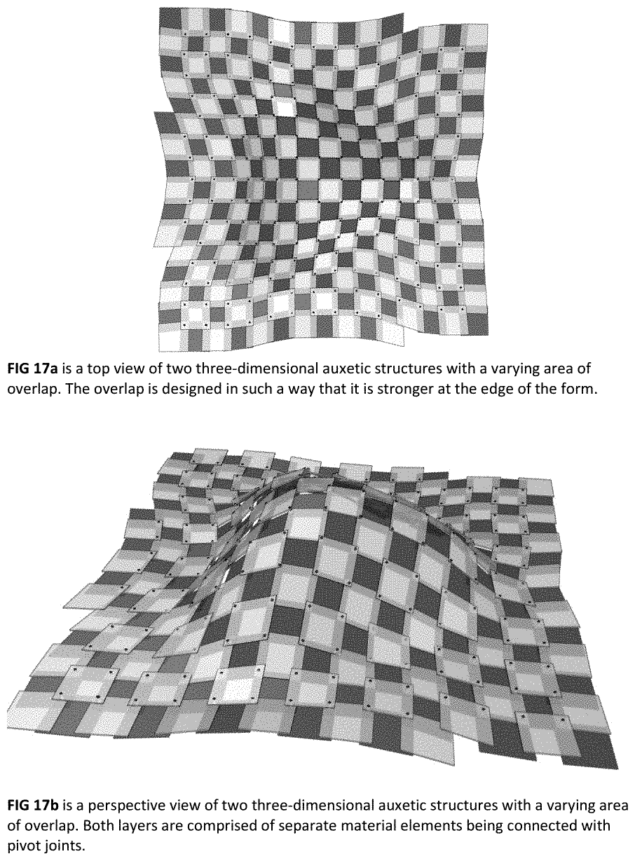

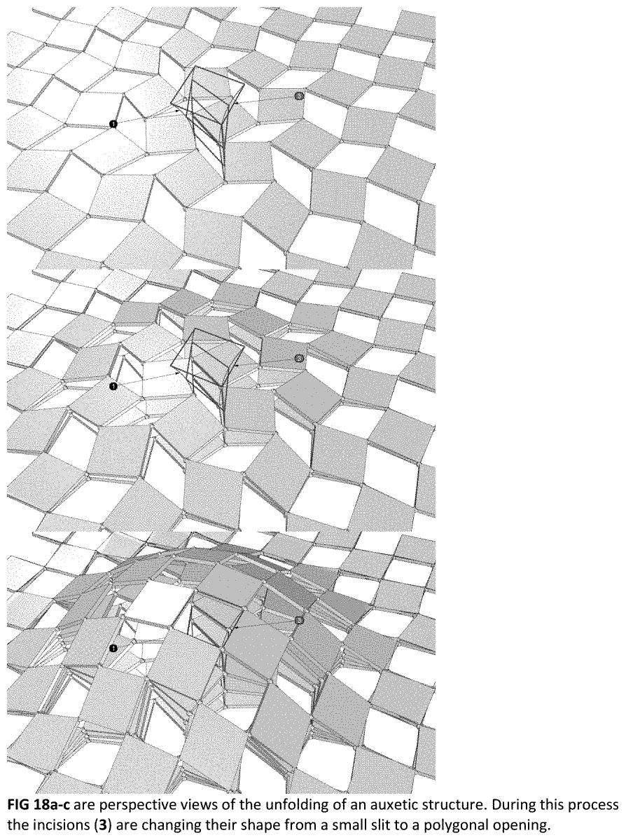

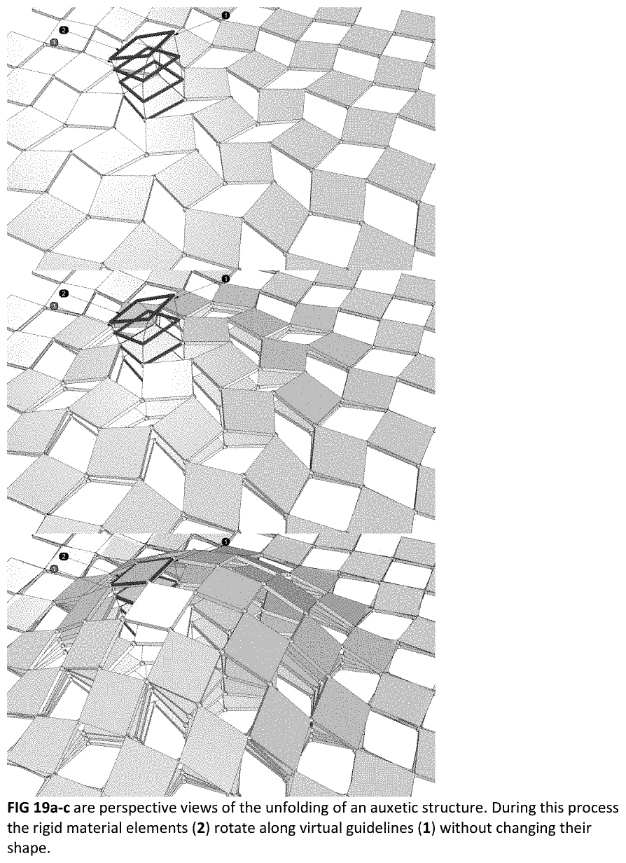

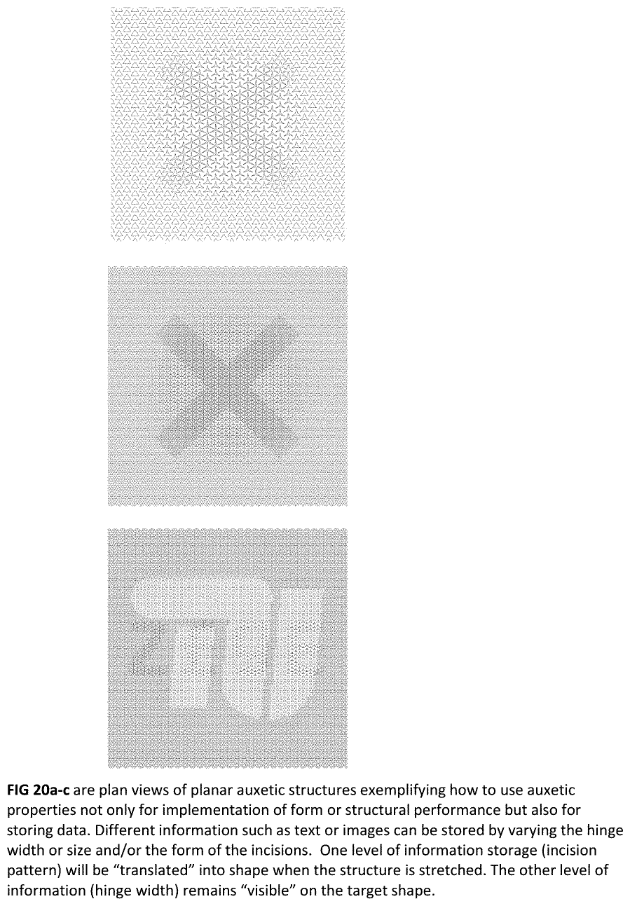

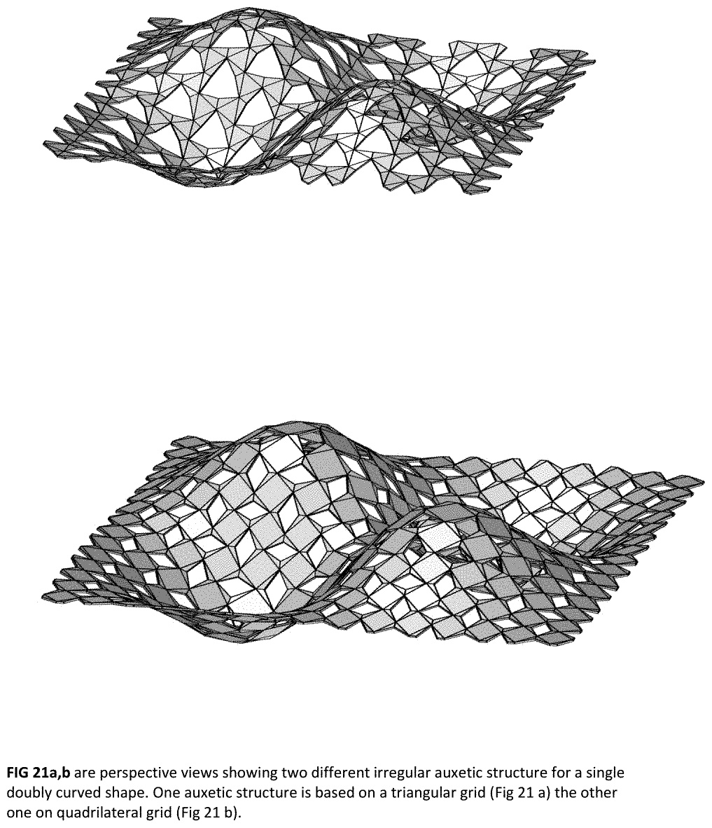

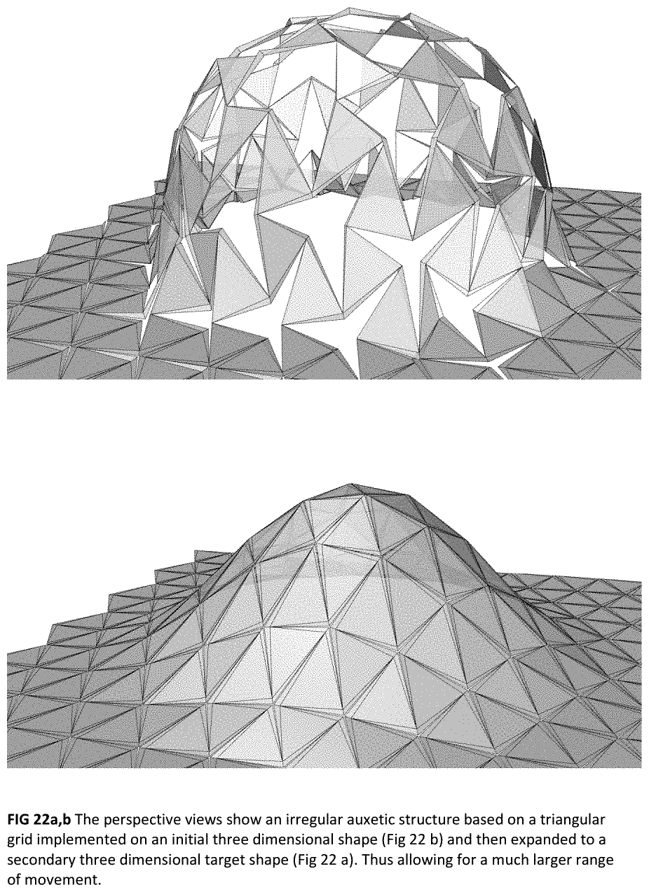

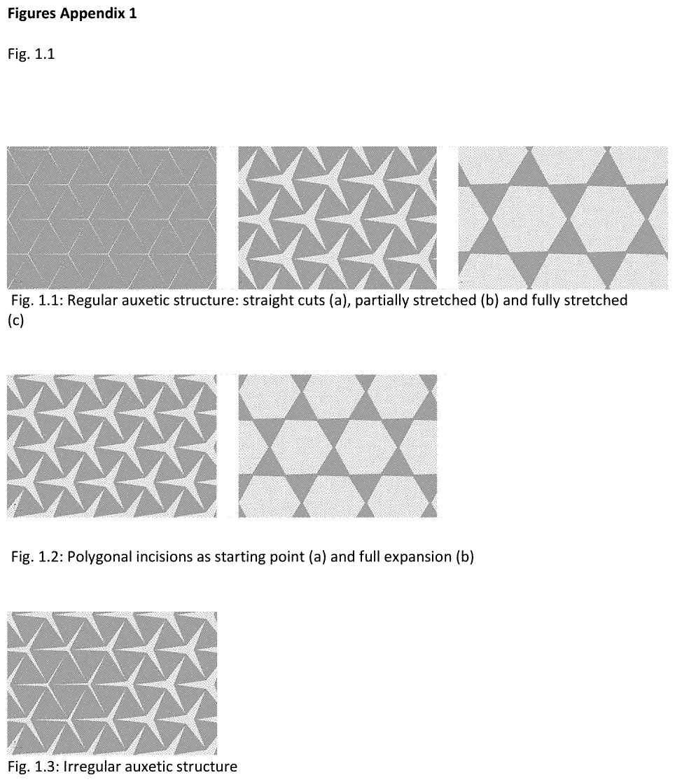

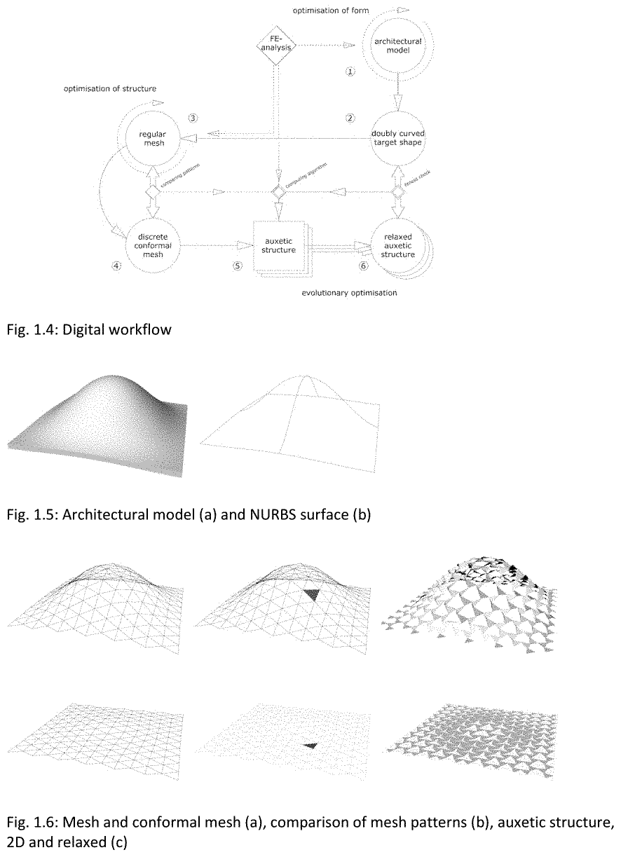

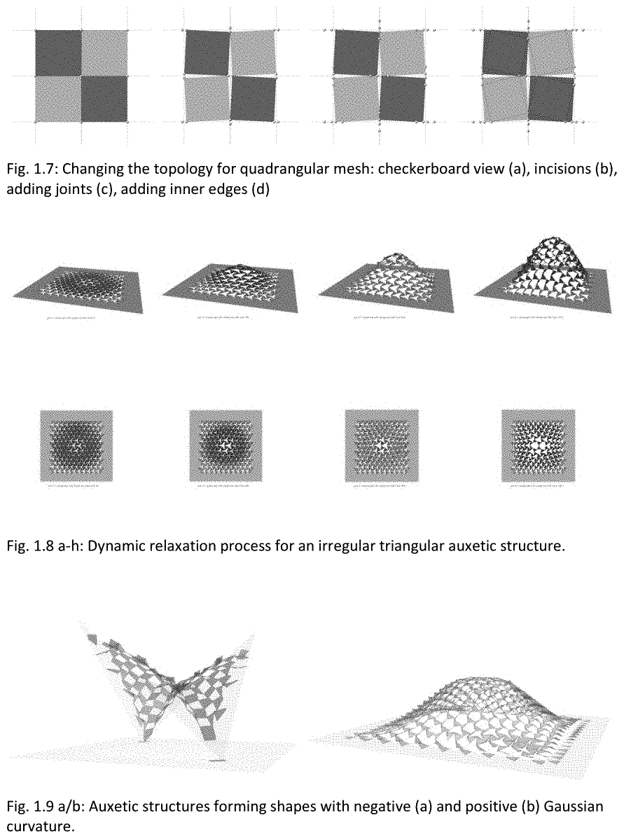

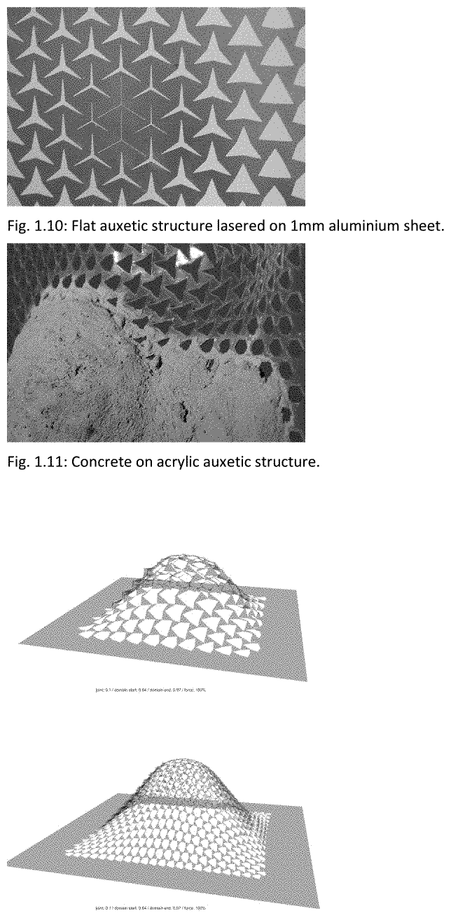

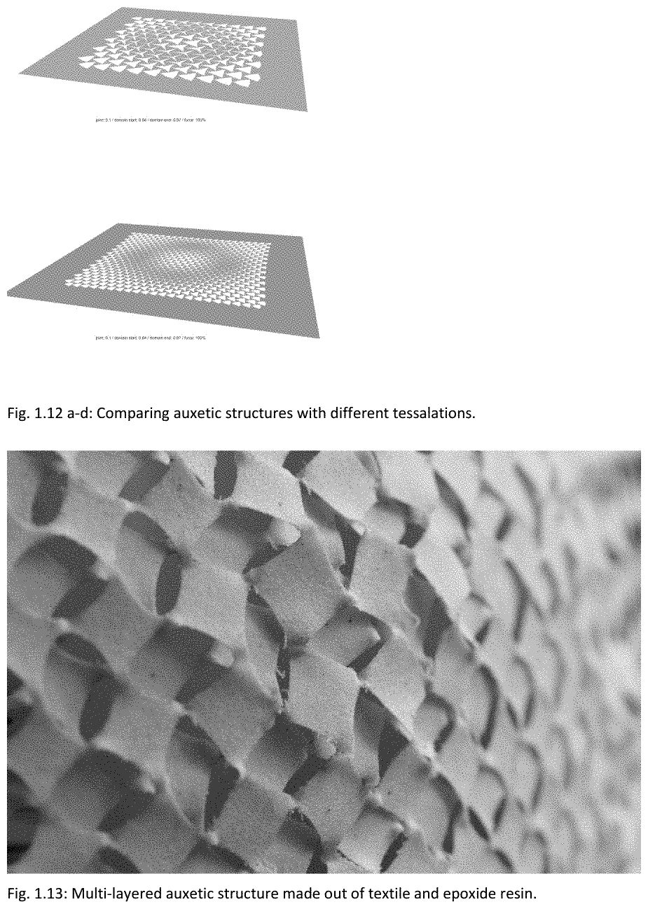

This patent is referring to irregular auxetic structures based on different kinds of grid structures (quadrilateral or tetragonal or a combination of both) resulting in different kinds of incision patterns (quadrilateral or hexagonal or a combination of both)(FIGS. 1a; 7a; 21a,b).

These grids can be regular or irregular.

There can be irregular incisions based on regular grid structures.

There can be irregular incisions based on irregular (i.e. distorted/deformed) grid structures FIGS. 12a; 13a).

### 5. Multi-Layering

This is referring to embodiments combining and layering several auxetic structures to receive structures with enhanced/extended/advanced characteristics/qualities/properties (9a-d; 16a,b; 17a,).

Two or more layer of auxetic structures can be combined to receive structures with different designable performances. (The interrelation of the structures causes new pattern and gives control over density and structural performance and patterning) (FIGS. 14a,b; 15a,b).

Controlling the incisions of corresponding auxetic structures at the starting structures (2D or 3D) means controlling the overlay auf this corresponding structures when stretched (on the target shape) (FIGS. 9a-d). The incisions for a desired overlay can be calculated. The desired overlay in the stretched state (on the target surface) can be designed and out of this the incisions can be calculated (FIGS. 16a,b; 17a,b).

### Goals:

### 5.1 Watertightness

In case of auxetic structures based on quadrilateral meshes/geometries at least two corresponding structure have to be combined to receive a watertight structure. FIGS. 9 a,b.

In case of auxetic structures based on trigonal meshes/geometries at least four corresponding structure have to be combined to receive a watertight structure.

### 5.2 Overlay Pattern

The overlay pattern is designable. It can be generated referring to desired properties of the starting shape or the target shape. (FIGS. 17a,b)

### 5.3 Structural Performance

The overlay of the structure can be used/designed for i.e. reasons of structural performance.

### 5.4 Decorative Patterns for Single Layers—for Multiple Layers

The irregular auxetic structure itself can be seen as decorative pattern (on 2D shape and on 3D shape). (FIGS. 14a; 15a).

The overlay of at least 2 different auxetic structures shows up as a decorative pattern. By controlling the incisions (2D and 3D) of corresponding layers of auxetic structures it is possible to get control over the overlay. This generates self-contained/original/patterns.

### 6. Auxetic Mechanism on 3D Shapes

### 6.1 Irregular Auxetic Structure on 3D Shape

This refers to irregular auxetic structures implemented on 3D shapes.

An irregular auxetic structure can also be implemented on a 3D shape. This makes it possible to design relating 3D geometries as long as they have the same genus/topology.

Comparing the topographical information of both starting and target 3D shape allows us to generate the irregular incision patterns of the starting shape—following the same algorithm as described in FIG. 22.

The calculation allows for controlling the movement from 3D starting shape to 3D target shape. This makes it possible to get control over the (global) movement and the intermediate steps during the deformation process. FIGS. 17a-c ; 18a-c).

The incision patterns on the starting shape can be implemented globally or locally. (BILDER) The deformation (stretching) process itself can be implemented globally or locally, resulting in differing movements from starting to target shape.

It is possible to calculate corresponding auxetic structures on 3D shapes as starting point as well. This allows for controlling the overlay to generate watertight structures and/or design the overly of the structures for i.e. reasons of structural performance.

### Appendix 1

Locally Varied Auxetic Structures for Doubly-Curved Shapes

### Abstract

In this appendix we present an innovative method for the simplified production of doubly curved construction elements.

We have developed a digital workflow in which spatial information of a given doubly curved shape is processed in such a way that they can be represented in a two-dimensional matrix. This matrix is materialized as an auxetic structure, i.e. a structure with negative transverse stretching or negative Poisson's ratio (Evans 2000). On a macroscopic scale, auxetic behaviour is obtained by making cuts in sheet materials according to a specific regular pattern. These cuts allow the material to act as a kinematic mechanism so that it can be stretched up to a certain point according to the incision pattern (Grima 2006, 2008).

Our innovative approach is based on the creation of auxetic structures with locally varying maximum extensibilities. By introducing variations of the incisions (Grima 2004, 2011) we allow local variations in the stretching potential of the structure. When all individual patterns are maximally stretched, the auxetic structure then results in a specific spatial shape.

Based on this approach we have created an iterative simulation process that allows us to easily identify the auxetic structure best approximating an arbitrary given surface (i.e. the target shape). Our algorithm makes it possible to transfer topological and topographical information of a given shape directly into a specific pattern. The expanded auxetic structure forms a matrix resembling the desired shape as much as possible. It can now be used as formwork. In a second iterative step, material specific information of the shape can be embedded in the auxetic structure by implementing FE-analysis into the algorithm.

As a result the expanded auxetic structure maps the force profile of the target figure. It can now also serve as reinforcement. By applying a second material like shot concrete, it is thus possible to produce building elements—without formwork.

### Introduction

Digital methods in architectural design have produced an increasing geometric complexity in recent years which in many cases requires challenging formwork for its production. Furthermore, parametric design methods tend to produce series of individual building components, each needing their own formwork, which is rendering the production process very onerous. Alternatives like 3D printing are being experimented with, yet these call for highly complex and exacting production processes. So the starting point of our research is to find out how the implementation of a new approach at the stage of the digital design process could facilitate the physical production downstream. Is it possible to represent certain aspects of a building component's geometry—like topology, topography and materiality—in a reproducible two-dimensional matrix? Could this matrix then be deformed in a way that would approximate the desired target shape as closely as possible?

The key to our answer lies in auxetic structures, i.e. flat materials made to exhibit auxetic behaviours through specific incisions, allowing for negative transverse stretching. These structures can then be formed into any bi-axially curved surface. By a subsequent deformation process, the cuts expand to polygonal openings and each area containing incisions turns into a spatial, grid-shaped matrix. In other words, we have a way of producing multiple 3D structures from one single 2D pattern. Our challenge is to figure out how to compute the specific 2D pattern that will lead to our one target 3D shape—this will be achieved through iterative manipulation of the auxetic structure.

### Related Works

The foundational works on auxetic structures from Evans and Grima and the investigations on Computational Design and Fabrication with Auxetic Materials (Konaković 2016) served as a starting point for the present study. The structural optimization and mapping implemented in our process is based on Discreet Conformal Mapping (Rörig 2014; Springborn 2008). The works of Ron Resch (Resch 1973) and the generalizing of Resch's patterns by and Tomohiro Tachi (Tachi 2013) served for the folding simulation. Daniel Piker's (Piker 2012) work on the digital simulation of auxetic structures and folding has given important impetus to the work. The idea of describing the auxetic structure as a kinematic linkage was inspired by Chuck Hobermans' reversibly expandable structures (Hoberman 2000). Digital processing tools were used for the structural optimization (VaryLab) and the implementation of stresses (Karamba).

### A NEW INTERPRETATION OF AUXETIC STRUCTURES

### Approach

An iterative method is proposed to computationally derive from a given shape a corresponding two-dimensional auxetic structure.

A closer analysis of auxetic structures is useful here. As mentioned before, auxetic behaviour is facilitated by specific incisions in the material while keeping significant vertices connected (FIG. 1.1a). It is the geometry of the structure that warrants kinematic movement, according to a given set of rules: adjacent faces always stay connected through one common vertice, around which they rotate according to an alternating clockwise/counter-clockwise pattern (similar to Hoberman's “reversibly expandable structures” (Hoberman 2000). The incisions need to divide the flat material in such a way that the resulting pattern exhibits the topology of a checkerboard (Piker 2012).

The incisions expand to polygonal openings through rotating the faces around the common vertices (we have chosen to focus exclusively on regular triangular and quadrangular patterns). The geometry itself determines the maximal potential for expansion, depending on the applied incision pattern. Therefore every fully-expanded auxetic structure results in a unique corresponding geometry.

Before this fully-expanded state is reached, a variety of shapes can be produced by expanding only parts of the structure. This local stretching will give rise to a local spatial deformation.

The potential for expansion is determined by the type of incision pattern. When a material has already been stretched to a certain extent, the further potential for expansion is limited. In these partially stretched structures, the incisions are showing up as polygonal openings (FIG. 1.1b, 1.1c). To improve the control of the deformation process, we are using already modified patterns as our new starting point: instead of straight incisions (FIG. 1.1a), we are performing polygonal incisions in the flat material (FIG. 1.2a) resulting in an auxetic structure with a lower but clearly definable potential for expansion (FIG. 1.2b). This variation in incision patterns can either be applied globally to the whole structure, or more locally depending on how strongly the corresponding area needs to be stretched.

In other words, varying between cuts and polygonal openings gives us precise control over the deformation for each pattern.

### Local Variation

Until now, research mainly focused on auxetic materials with a regular incision pattern (i.e. straight cuts as in FIG. 1.1, FIG. 1.2). When a regular structure is evenly stretched to its maximum, it remains two-dimensional; every cut turns into a regular polygonal opening (FIG. 1.1c, FIG. 1.2b). However if you stretch a regular structure locally (i.e. perpendicular to the plane), these areas will deform spatially; the incisions in the stretched part, and only those, turn into polygonal openings.

Consequently, an irregular structure (FIG. 1.3) stretched at every point to its maximum results in a single three-dimensional shape, every incision turning into a polygonal opening. The more the polygonal incision in a certain area of the two-dimensional pattern differs from a regular cut, the lower the three-dimensional distortion in this area of the resulting shape will be.

Such a structure, when completely stretched, can thus be made to take on a precise spatial shape. Conveniently, our method allows to determine up front the auxetic structure corresponding to a given shape. We have developed a procedure by which the type of incision for each individual element of the auxetic structure is determined in such a way that, once fully extended, the entire structure comes as close as possible to the target shape.

Creating an Auxetic Structure from a Mesh

As previously described, auxetic structures have a clear topology. They are based on homogeneous triangular or quadrangular tessellations, thus the facets can be assigned two alternating colours in a checkerboard pattern (FIG. 1.7a). Mathematically, such a pattern can be described as a triangulated or quadrangulated mesh. The computational transformation of the mesh topology is having the same effect as incisions in the two-dimensional material. The advantage is that changing mesh topology is a scriptable process that can be easily computed and iterated. Stretching can be simulated just as well. When the mesh is stretched, the topology stays the same. When the cuts expand into polygonal openings, the topology also stays the same. By adding the relevant incisions (i.e. changing the topology), the resulting mesh clearly describes a specific auxetic structure.

Hence all that is needed in order to create an auxetic structure off the back of a given shape is to produce a regular mesh. This can be done using established algorithms for triangulated or quadrangulated meshes—in our approach we used VaryLab, a software for discrete surface optimization and parametrization.

Our regular mesh now serves to produce the desired auxetic structure. Since it is directly based on this mesh, we can steer the incisions and polygonal openings of the auxetic structure directly through the mesh, so that each individual pattern of the auxetic structure is linked to a specific mesh face.

We will show in the following exactly how the size of the individual mesh faces can be used to proportionally determine the size of the incisions in the auxetic structure.

### Digital Workflow

We start with a computationally designed shape (architectural model, FIG. 1.5a). This normally is a NURBS surface (FIG. 1.5b). To develop the auxetic structure the surface of our doubly curved target shape needs first to be converted into a regular mesh (FIG. 1.6a). The smooth surface is divided up in discrete patterns. There is a variety of computational tools available to do so. The resulting mesh must be either purely triangular or rectangular—depending which pattern of the auxetic structure is to be used, and needs to be represented in a checkerboard pattern. In a first optimization process the 3D mesh can be modified by implementing information from the FE-analysis of the shape. The mesh topology remains the same.

At this stage, a discreet conformal 2D mesh (FIG. 1.6a) can be generated from the 3D mesh (Rörig 2014; Springborn 2008). Again, this one will exhibit the same mesh topology and form the basis of the auxetic structure. 2D and 3D meshes can now be compared with each other to assess the degree of deformation for each of the corresponding mesh faces (FIG. 1.6b). This serves as a basis for the size of the incisions making up the auxetic structure. In the case of large differences between corresponding mesh-faces, that area of the auxetic structure will need to be highly extensible, i.e. incisions will have to be smaller. Where smaller differences in size appear, hardly any expansion is needed; incisions will resemble widely open polygons.

A programmed algorithm determines the type and size of incisions needed to create an auxetic structure that locally allows exactly those distortions that will globally result in the target shape (FIG. 1.6c).

### Materiality—Introduction of Stresses and Verification

A dynamic relaxation process is introduced in order to check the conformity of the generated auxetic structure with the target shape. To allow for this, the auxetic structure has to be modelled as a kinematic linkage (FIG. 1.7b), as previously described. We bring in materiality by assigning a specific width to each joint (FIG. 1.7c). To avoid plastic deformation in our simulation, further inner edges have to be implemented (FIG. 1.7d). Each of these inner edges is modelled as a linear piano hinge joint to warrant a clearly defined deformation. The resulting structure of clean simulated folds bears resemblance with Ron Resch's patterns (Resch 1973). The relaxation process can now be computed as a folding process. At a later stage, the results of the original shape's FE-analysis (obtained with Karamba) could be introduced into the auxetic structure by varying the width of the joints in relation to the amount of stress.

The two-dimensional auxetic structure we modelled in this way is now relaxed through a simulated dynamic relaxation process (FIG. 1.8). The result is compared with the target shape and deviations are identified. Green colour indicates a good fitness, red colour a bad fitness. Based on these results, the auxetic structure can now be repeatedly modified and rebuilt to compare with the target shape after dynamic relaxation. In a simplified version of this optimization process we only take into account the purely geometric parameters for the relaxation (no variation of joint width). Material properties and stresses can be introduced in a more complex optimization. This iterative process will deliver a range of two-dimensional auxetic structures, each more closely approximating the target shape.

### Fabrication and Materiality

The presented method shows an integrated computational process for geometric analysis and form finding. It can be applied to surfaces with both a positive or negative Gaussian curvature (FIG. 1.9a, FIG. 1.9b) as well as to figures with fixed or free edges.

Without any further intermediate step, the auxetic structure can now be produced by means of laser-cutting or punching from metal sheets (FIG. 1.10) or material. In its expanded form, the three-dimensional matrix serves as formwork and reinforcement for shotcrete (FIG. 1.11).

The absolute size of the incisions and thus also the proportions of the underlying mesh are determined by the requirements of the shotcrete (FIG. 1.12). Depending on the size of the forces to be transmitted, multi-layer materials are also conceivable. Overlapping layers even allow to create a bigger, much more complex form made up of smaller individual elements.

### Conclusion

The integrated process presented in this paper allows us to translate doubly curved shapes into an irregular two-dimensional auxetic structure. When fully stretched, the resulting matrix exhibits the geometry of the target shape.

The auxetic structure itself can be produced through laser cutting or stamping different materials: sheet metal can be used here as well as textiles. The subsequent three-dimensional stretching of the auxetic structure can be done through a robotically controlled gradual distortion or by relaxation for textiles. Depending on the material, the spatial matrix can be used as a lost formwork and/or reinforcement for shotcrete. The latter case in particular bears the greatest potential, since complex formwork could be dispensed with. The use of resin-impregnated textile materials also promises great opportunities, as the relaxation process happens naturally thanks to gravity! Another conceivable application of the matrix could be as a facade element with a unique functionality and aesthetic unprecedented in traditional manufacturing processes.

Our approach will greatly simplify the construction of complex architectural forms as we know it. Our design process makes it possible, based on a virtual architectural model, to introduce form, structure and material information into the auxetic structure in a single step. Further down the line in the construction process, it does away with complex formwork, offering reinforcement to boot.

### REFERENCES

Evans, K. E.; Alderson, A., 2000: Auxetic materials: Functional materials and structures from lateral thinking! Advanced Materials 12, 9, pp. 617-628.

Grima, J. N.; Evans, K. E., 2006: Auxetic behavior from rotating triangles. J MATER SCI 41, pp. 3193-3196.

Grima, J. N.; Alderson A.; Evans, K. E., 2004: Negative Poisson's ratio from rotating rectangles. Computational Methods in Science and Technology 10 (2), pp. 137-145.

Grima, J. N.; Farrugia, P. S.; Caruana, C.; Gatt, R.; Attard, D., 2008: Auxetic behaviour from stretching connected squares. Journal of Materials Science 43(17), pp. 5962-5971.

Grima, J. N.; Manicaro, E.; Attard, D., 2011: Auxetic behaviour from connected different-sized squares and rectangles. Proceedings of the Royal Society A 467(2121), pp. 439-458.

Hoberman, C., 2000: Reversibly Expandable structures having polygon links. U.S. Pat. No. 6,082,056.

Konaković, M.; Crane, K.; Deng, B.; Bouaziz, S.; Piker, D.; Pauly, M., 2016: Beyond developable: Computational design and fabrication with auxetic materials. SIGGRAPH Technical Paper, Jul. 24-28, 2016.

Piker, D., 2012: Variation from uniformity. https://spacesymmetrystructure.wordpress.com.

Resch, R. D., 1973: The topological design of sculptural and architectural systems. Proceedings of the Jun. 4-8,1973, National Computer Conference and Exposition, AFIPS '73, pp. 643-650.

Rörig, T.; Sechelmann, S.; Kycia, A.; Fleischmann, M., 2014: Surface panelization using periodic conformal maps. Advances in Architectural Geometry, pp. 199-214.

Springborn, B.; Schröder, P.; Pinkall, U., 2008: Conformal Equivalence of Triangle Meshes. ACM Transactions on Graphics 27(3).

Tachi, T., 2013: Freeform origami tesselations by generalizing Resch's patterns. Proceedings of the ASME, DETC2013-12326.

Karamba: Preisinger, C.,: http://www.karamba3d.com.

VaryLab: Sechelmann, S.; Rörig, T., 2013: http://www.varylab.com.

### Appendix 2

### Experimental Investigation of Digital Production of Architecture

Digital modelling for the construction of free-form surfaces by means of auxetic structures

The digitalization of the design process in architecture allows the drafting and the calculation of nearly any component geometry. However, their manufacture involves many major challenges. Manufacturing methods, such as the transfer of 3D-printing to the architectural scale or robotic manufacturing methods, promise solutions for this, but are still far removed from maturity for series production. This project identifies options within the digital design process for the optimization of the designed components with regard to their ability to be constructed in the future. The described approach relates to auxetic structures, i.e. structures with a negative lateral extension, the inherent properties of which mean that they can be shaped into all kinds of spatial surfaces including surfaces which are curved in two axes and which therefore have the potential for the creation of free-form components. This deformation option—their auxetic properties—is created on the macro-level by specific sequences of cuts in normally rigid two-dimensional materials. The information about the topology and topography of a “free-form surface” can be modelled in the two-dimensional cut patterns of auxetic structures. These structures can then be shaped as desired by stretching them. In such a case, it is the manipulation of the originally regular pattern, which defines the limitations of movement of the auxetic structure, so that the desired starting shape can be created accurately. In their stretched spatial configuration, the auxetic structure forms a matrix, which, in conjunction with concrete, results in a free-form component.

Introduction

1.0 Digital modelling
1.1 Digital modelling—digital production
1.2 Fundamentals of modelling
1.3 Modelling in architecture

2.0 Digital production
2.1 Shape definition and implementation
2.2 Approaches in digital production
2.3 Criticism and outlook
2.4 Digital optimisation—topological optimisation

3.0 Auxetic structures
3.1 What are auxetic structures?
3.2 Manufacture of auxetic structures
3.3 Modelling of auxetic structures
3.4 Regular auxetic structures
3.5 Irregular auxetic structures

4.0 Description of the digital model
4.1 Auxetic structures as a mesh
4.2 Meshes as mathematical models
4.3 Mapping of the topology
   4.3.1 Mapping as a method
   4.3.2 Two mapping methods
4.4 Comparison of the areas in 2D and 3D as a method
4.5 Network optimisation
4.6 Shape optimisation—networks as models of grid shells
4.7 Structure optimisation

5.0 Auxetic structures for creation of free-form surfaces
5.1 Modelling—description of the digital setup of the experiment
5.2 Mapping of the topology—connection between the two-dimensional shape and the three-dimensional structure
5.3 Mapping of the topography—comparison of the areas
5.4 Mapping of the materiality—implications of static properties
5.5 Quantification by means of evolutionary optimisation
   5.5.1 Auxetic structure as spring model

6.0 Production and application
6.1 Manufacture of the auxetic structure
6.2 Facing element
6.3 Composite with concrete
6.4 Outlook on an architecture

7.0 References

8.0 FIGS.

### 1.0 Digital Modelling

### 1.1 Digital Modelling—Digital Production

Every architectural draft is also always influenced by the technical options for its feasibility. In it, the cultural, sociological but also technical aspects of its time are reflected. Progresses in construction technology but also the invention of new tools, materials and technologies therefore have a direct influence on the draft designer and thereby also on the draft itself. It therefore always relates to the technical options available in its time.

A further aspect of a draft is that it is, by nature, always a model. The future building is pre-conceived. Its future appearance is shown in an abstract form while, at the same time, the draft gives initial instructions for its manufacture. In the concrete form of the relevant model, the influences of its time are also directly reflected. The model and the method of modelling are therefore inseparably connected to their temporal context with its cultural, sociological and technical conditions.

One of the serious cultural and technical changes during recent decades is digitalization. It has a direct influence on the architectural drafting practice and the way, in which drafts are conceptualized and transmitted as models and instructions for architectural construction. The large number of new digital production techniques and tools allows the conceptualization, drafting and construction of entirely novel shapes. Here the question may remain unanswered, whether tools form the condition for imagination of new designs or if they are themselves the results of a design process.

For the investigation into how digitalization concretely changes the drafting process in the form of a model, it is useful to, once again, concretely investigate the criteria of modelling.

1.2 Fundamentals of Modelling

Herbert Stachoviak provides in his modelling theory a comprehensive description of what modelling is and which features characterize a model. In summary, every model has three characteristics, which mark the relationship to the object described by the model:

Firstly, the mapping characteristic:

“Models are always models of something; they are maps or representations of natural or artificial originals, which themselves can be models.”¹ ¹ Stachoviak, H. 1984, page 131

Secondly, the simplification characteristic:

“In general, models do not cover all of the attributes of the originals they represent, but only those which appear to be relevant to the creators and/or users of the models.”² ² ibid. page 132

Thirdly the pragmatic characteristic:

“Models are not per se unambiguously correlated with their originals. They fulfil their substitution function a) for specific ( . . . ) subjects (for whom?), b) within specific time intervals (when?) and c) with restriction to specific notional or actual operations (to what?).”³ ³ ibid. page 133

### 1.3 Modelling in Architecture

Applied to the architectural draft, this means that it is the representation of the future original, for example a house (mapping characteristic). In this case, it is irrelevant which form is used for the representation. It can be a three-dimensional object, a drawing or a diagram. Depending on the function of the specific draft, only certain parts are shown (simplification characteristic). Drawings are, for example, only two-dimensional representations of objects; lines in drawings can represent entire walls. Finally, the draft has to serve a specific time-dependent purpose (pragmatic characteristic): in the form of a sketch, it can, for example, rapidly depict a specific detail or in the form of a competition it can be used for creating an order. ⁴ See Stachoviak, H. 1984, page 175“One of the best-known and most mature models that has long been used in mathematics without describing it as such is analytic geometry. It can be understood as an arithmetic model of geometry ( . . . ). For example, in every point of the Euclidean space, a pair of numbers (if we restrict ourselves to the two-dimensional case) on every straight line corresponds to a linear equation and the various geometric figures correspond to different systems of equations and inequalities.”⁵see https://de.wikipedia.org/wiki/Poissonzahl⁶ see Pauly, M. 2016⁷ ibid.⁸ see Pottmann, H. 2010, page 393 f⁹ ibid. page 392¹⁰ ibid. page 387¹¹ Comprehensive descriptions are found, in particular, in “IL 10- Gitterschalen”, “Das Hängende Dach” and “Selbstbildung and Form”¹² Pottmann, H. 2010, page 402¹³ Sigrid Adriaenssens, S. page 181¹⁴ see Sigrid Adriaenssens, S.

Independently of the time of their creation, drafts, being models of and for architecture, always possess these characteristics. Digitalization of the drafting practice may change the concrete form of the models, which are used for editing and transforming the draft, but these three characteristics are always maintained. This project will attempt to show below, how it is possible, by means of digital modelling, to represent more of the properties of the represented object in the model and thereby to simplify the original. [FIG. 2.1]

### 2.0 Digital Production

### 2.1 Shape Definition and Implementation

At the centre of this project is the question how free forms resulting from the architectural design process can be transformed into components. The starting point is therefore the shape definition given by the architect. In this context, it does not matter initially, whether the components are individual facing elements, larger components or even entire trusses. There is always the problem of having to produce, at a high cost, the shapes for the production of these components. [FIG. 2.2; FIG. 2.3] The “shape” might, for example, be the formwork of a mould, which, due to the geometry, cannot be produced from linear or planar standard panels. The difficulty becomes even clearer when these free-form components have to be produced by means of, for example, a punching tool. Here, the discrepancy between the serial repetition, which can easily be produced by means of such tools, and the digital, ever-varied series is most clearly apparent. Every component would require a separate tool for its production, or the same tool would have to be repeatedly modified.

### 2.2 Approaches in Digital Production

Approaches to the production of free-form components are currently seen in the possibilities provided by additive manufacturing. The 3D-printing technology has long been transferred to the scale of the architecture as a method for the construction of prototypes and models. Various processes and different machines are being tested worldwide for printing concrete directly and thereby to be able to produce any desired geometry without the need for formwork. Examples of this are the studies on concrete printing by Foster and Partners in collaboration with Loughborough University. By means of a robot, it is possible to print layers of a two-shell construction to make free-form components. [FIG. 2.4] The Shanghai-based construction company WinSun is already producing up to four-storey houses from 3D-printed components. However, these approaches have one glaring system-inherent defect—it is concrete that is being printed. This means that the created components can only transmit compressive forces. What is actually searched for is a process that enables the manufacture of reinforced concrete components. Again, there are approaches which involve the transfer of 3D-printing technology. The research group led by Gammatio Kohler is attempting, in their Mesh Mould Metal research project, to print by means of a robot the “statically effective reinforcement system three-dimensionally and in a second step to investigate the interaction of such printed structures with concrete”. [FIG. 2.5]

### 2.3 Criticism and Outlook

The paths taken have one crucial fault. They are not robust. The issue is the chosen approach, which is the attempt to solve the complex task in hand by means of ever more technology. This initiates a cycle, in which the production deploys more and more technology whilst also becoming increasingly vulnerable. It would be easier and more appropriate to the logic of digital design, to implement an optimization of the future production process much earlier within the process chain. The question is how to use the digital design and form creation methods to optimize the manufacturing process before the production has even started. Herein lies the actual opportunity of digital production: optimization as part of the digital design, before the actual production.

Can there therefore be an approach for the optimization of the shapes during the digital design process in such a way that the future production is considerably simplified? This project will deal with this issue below and will try to give an answer on the basis of the concrete approach described.

### 2.4 Digital Optimisation—Topological Optimisation

How can by the analysis of the methods, on which the digital form creation itself is based, parameters be identified that simplify the later physical production? How can these simplifications be implemented in the design process of the model of the represented object?

First of all, the mathematical algorithms, on which the digital form creation is based, indicate the direction. For example, the analytical geometry can itself be understood as an arithmetic model of the geometry. A number pair is assigned to each point in the Euclidean space. The algorithm determines the relationship of the pairs of numbers to each other and therefore the topology of the generated geometry.⁴ I will return to these number pairs and the algorithms controlling them. These two factors, number pairs or number triplets (relating to three-dimensional space) and the algorithms describing the relationship to each other form therefore the mathematical model of the three-dimensional body. Is it possible to identify simplifications or patterns that make it possible to simplify the three-dimensional information to two-dimensional and to replace number triplets with number pairs? Yes, there is a commonly used method available within computational design: It is mapping. It is always deployed when spatial geometries have to be equipped with textures and two-dimensional texture coordinates have to be assigned to the points on the surface of the geometry! This is the approach I am pursuing. I am looking for a two-dimensional representation of the three-dimensional architectural body. It is obtained by means of conformal mapping. [FIG. 2.6]

This transformation is an entirely mathematical process. As such, it is a commonly used operation available within digital design programs and therefore a part of the digital processes that take place before the actual production.

This means that the model for the shape generation simultaneously contains the method for the reduction to two dimensions.

In the first step, it is therefore possible to represent the topological planning information of a three-dimensional architectural figure in a topologically equivalent two-dimensional surface. The question now is, how it can be achieved that the topographical information of the spatial figure in this two-dimensional surface is represented in such a way that in a further step it is possible to re-create a three-dimensional body from this two-dimensional model. The key to this is provided by auxetic structures!

### 3.0 Auxetic Structures

The approach consists of using the means and possibilities of digital form finding and processing methods as well as calculations to analyse the digital information belonging to the three-dimensional structures created during the design stage in such a way that their topological and topographical information can be represented in a two-dimensional structure. As shown above, by conformal mapping of the three-dimensional bodies, their topological structures can be represented on a two-dimensional surface. For the purpose of mapping, the topographic information of the three-dimensional bodies onto this two-dimensional surface, they are transformed into auxetic structures. [FIG. 2.7; FIG. 2.8]

### 3.1 What is an Auxetic Structure?

Most materials become narrower when they are stretched in one direction. They have a positive Poisson number, which is a material-dependent elastic constant.⁵ However, there are also materials with a negative Poisson number. This means that, for these materials, a longitudinal strain simultaneously results in a transverse strain. Such materials are called auxetic. Depending on the material, the transverse strain can occur in two or even three spatial directions.

In the following, special planar auxetic structures will be examined, which exhibit extension in two directions in space.

### 3.2 Manufacture of Auxetic Structures

Special principles of structural design make it possible for auxetic materials to display their particular behaviour. These principles can be abstracted. In this way, materials can be produced, which also show auxetic properties at the macroscopic level. For this project, in particular, planar structures were investigated.

The starting materials for the creation of structures with auxetic behaviour are flat, barely expansible materials. With regard to this project, initially, cardboard or thick paper was used and later, sheet metal or woven fabrics.

By means of specific cuts into the material, it is possible to induce auxetic behaviour. Here the cuts follow clear geometrical requirements.

Two different patterns will be investigated:

Pattern 1: Hexagonal: The cut pattern consists of regular star-shaped cuts, each with three legs. Stretching results in hexagonal openings. This trihexagonal pattern is also known as kagome lattice. During this process, the surface expands to four times its size.

Pattern 2: Quadrangular: The cut pattern is formed from regular linear cuts, which are turned alternately by 90 degrees as on a chess board. Stretching results in square openings. During this process the surface of the pattern is doubled.

### 3.3 Modelling of Auxetic Structures

The cuts in the pattern are made in such a way that the elements formed by the cuts can rotate with respect to their neighbours. The locations between the individual cuts where the individual elements remain connected are called webs or joints. These joints form the geometric centre of the rotation. These rotational movements are coupled in such a way that they turn in opposite directions. At the same time, the cuts between the individual elements are gradually widened forming openings. The area is expanded evenly until the limits given above have been reached.⁶

There are two approaches for the description of the deformation of the pattern: when the cut pattern is stretched, the joints deform plastically. Depending on the widths of the webs, more or less energy has to be expended to achieve this deformation. When the deformation is carried out, the joints move from the plane.

Another approach is to consider the entire pattern as a convolution. The webs become kinks where the pattern can fold. Since, for geometric reasons, these folds at the webs are all in the same direction (i.e. all of them are either mountain folds or valley folds), it is necessary to add further folds to the pattern to compensate for this single-sided movement. This method was chosen to model the deformation on a computer. At this point, I am also pointing out the structural similarity of the described auxetic structures to the Ron Resch convolution, which is named after its discoverer. The regular cuts in the pattern creating the auxetic behaviour correspond to the valley folds in the Ron Resch convolution. The additional folds created by the computer when making the model correspond to the mountain folds in the Ron Resch convolution. [FIG. 2.9]

### 3.4 Regular Auxetic Structures

Regularly arranged cuts in the material result in regular auxetic structures. If these structures are stretched in the longitudinal direction, the structure deforms rigidly across the entire pattern. All elements rotate simultaneously with regard to their respective neighbours. The pattern expands within the plane, resulting in a uniform change of both length and width.

However, if regular auxetic structures are stretched in the transverse direction, this leads to irregular, localised 3-dimensional deformations. The structure expands into space until the stretch limit of the relevant pattern is reached. Once this has been reached, neighbouring patterns are stretched via the connecting webs, until their stretch limit has also been reached. Because of this property, that the pattern has a locally varying deformability, it is possible to obtain biaxially curved deformations with these structures. This is the decisive advantage of auxetic structures. “The fact that these materials are flat initially makes them attractive for fabrication.”⁷ Furthermore, it is possible to use these structures to approximate almost any spatially curved surface.

With the option to implement auxetic behaviour on the macroscopic level by means of cuts into normally non-stretchable planar materials and thereby enable their spatial deformation, a decisive step has been taken. These auxetic structures and the relationship between the exact shape and arrangement of the cuts in the flat surface and the corresponding local deformability at the cuts, form the core of the following investigations.

### 3.5 Irregular Auxetic Structures

Depending on the degree of stretching, the cuts enabling the auxetic deformability are opened to different degrees. If, however, greater openings are cut out of the flat substrate instead of simply cutting slits into it, the pattern retains its auxetic behaviour, but the maximum extensibility is decreased. In this way, the extensibility can be limited as desired, even to the extent that no movement is possible and therefore no stretching. This can be done globally across the entire pattern or locally in a differentiated way. If it is carried out uniformly, the pattern may continue to stretch until its maximum is reached, or localised spatial deformations are able to be made, but these will be drawn back into the plane if the pattern is stretched any further. If the cuts are, however, varied locally, local spatial deformations are retained even if the entire structure is stretched further. In this case, the restriction of the planar extension then results in the local pattern with the lowest deformation potential.

A different aspect is that the following is implied for an auxetic structure with locally irregular cuts: If, at each point, the structure is stretched to its maximum, those areas of the pattern with a greater potential for deformation, i.e. those with smaller cuts, will deform in space!

It is therefore possible to create a direct relationship between the type and arrangement of the structure-forming pattern and the actual surface, which describes this structure in its stretched status.

The aim is now the reversion of this path, i.e. to start with the desired three-dimensional surface and to identify the cut pattern, with which the stretched auxetic structure best approximates the original surface.

### 4.0 Description of the Digital Model

How can it be achieved that for any given surface (shape) the auxetic structure is identified which best approaches it?

Specifically, the task is to create a model, which helps to represent the design in the form of a computable digital model.

First of all, the following applies:

The auxetic structures have a specific topological structure. Only this structure, the shape and arrangement of the cuts into the plane are the fundamental prerequisites for the presence of an auxetic behaviour. [FIG. 2.13; FIG. 2.14] Gradual changes to the cuts will not change the topology. The starting and end points of the cuts into the surface and their relative positions can be described in the form of a matrix. They form a network, within which the individual points are correlated to each other. Within this network, the arrangement of the points with regard to each other is not varied, even if the actual distances between points or the proportions are changed. The network topology is therefore retained. The mathematical description of this network is a matrix, the digital model is a mesh (network).

Being a mesh, the auxetic structure can now be straightforwardly modelled in a computer.

### 4.1 Auxetic Structures as a Mesh

The auxetic structure can therefore be modelled as a complex mesh. In the further process, it is, however, useful if this complex mesh is simplified. As for further analysis a method is described, in which only the relative sizes of the areas/meshes to each other are relevant, it has been achieved that the complex network of the auxetic structure is able to be mapped onto a simplified mesh. The network topology is simplified. For auxetic structures with hexagonal meshes a regular tetragonal mesh with regular corners with a valence of 6 is obtained. This means that at each of the regular nodes six edges meet. Auxetic structures with rectangular meshes are mapped onto a quadrilateral mesh. Here, the regular edges have a valence of 4, meaning that at each of the regular nodes four edges meet.⁸

The advantage of these simplified meshes is that they can be mathematically calculated more rapidly and that they offer the option of modelling and analyzing them by means of a great variety of digital tools.

### 4.2 Meshes as Mathematical Models

The term “mesh” was used here initially only for the topological description of the composition of the auxetic structure. However, the mesh is mostly used for the geometrical description of bodies and surfaces. “Networks are so-called discrete representations of surfaces”.⁹ In addition to NURBS surfaces, they are used for the description of curved surfaces and can easily be modelled on a computer. “Roughly speaking, a network is a set of points, which structure its basic elements, the so-called meshes. The meshes are bounded by polygons. In most cases, one type of polygon dominates (e.g. triangle, quadrangle, sexangle). They are connected along their edges and roughly describe the shape of a smooth surface.”¹⁰

By means of the model of the meshes, it is now possible to relate flat auxetic structures to three-dimensional surfaces. In order to be able to compare two meshes with each other, it is first of all necessary, that they have the same network topology.

### 4.3 Mapping of the Topology

### 4.3.1 Mapping as a Method

The question of how the distances between points on spatial surfaces are transferred to a two-dimensional plane, is one of the central issues of geography. It is the problem of map making. Depending on the purpose of the map to be created, there are a large number of options how to project points on the three-dimensional surface onto a two-dimensional map. For example, the relationship of the mapped points can preserve either the true area or the true angles, but never both at the same time. In other cases, projections are possible, which are neither true to area or angle, but in which the relationship between the individual points are given a further, different relevance. [FIG. 2.10; FIG. 2.11] It is, however, important that the relationships between the mapped points, their network topology, continue to correspond to the relationship structure between the points on the spatial surface. Original and projection have to have the same network topology.

In the area of computational design, the problem of linking three-dimensional surfaces to two-dimensional planes re-appears in a different situation. If the spatial surfaces are supposed to have a texture applied, it is necessary to link each point of the three-dimensional surface to its corresponding two-dimensional area, its map. The xy coordinates on the devolved three-dimensional surface are linked to the uv coordinates on the map. For the solution of this task, a wide range of options is available in the digital programs, which will not be described here in any more detail. The question of how to link two-dimensional to three-dimensional surfaces while maintaining a shared network topology is an explicit component of the digital process and it is essential that every software packet provides many different tools for this purpose.

### 4.3.2 Two Mapping Methods

Two devolution methods will be explained here briefly:

By means of projection, the individual points on a surface (and the relationships between them) are projected onto a plane. The projection can be either a parallel projection or a central projection and the plane can also be tilted. The projection is an easy option to create a two-dimensional representation of the three-dimensional surface. However, this map normally preserves neither the angles nor the areas. If the projection is a parallel projection onto a plane, which is orthogonal to the projection direction, the edge curve is, however, maintained!

A further method of devolution is the angle-preserving projection—conformal mapping. The map of the three-dimensional surface shows the same angular relationships between the points as those seen on the mapped surface. The distances between the points are, however, changed. The two methods described are algorithms and therefore clearly elements of the digital process chain and they play a decisive role when creating auxetic structures. By means of these tools, in this initial step of model creation, the topological information on the link between the two-dimensional and three-dimensional surface is achieved. [FIG. 2.12]

### 4.4 Comparison of the Areas in 2D and 3D as a Method

With the methods for devolution and mapping, I obtained two different, corresponding maps. Both have the same network topology. This allows a comparison. The selected comparison criterion is the difference of the area size of corresponding network meshes within the two-dimensional mesh and the three-dimensional mesh. Initially, only the relative change in the area size is relevant. Locations, at which major three-dimensional deformations occur, are the same where greater differences occur compared to the two-dimensional area sizes between the corresponding network meshes. Where the spatial deformations are small, these differences are also minor.

Qualitative information about the deformation of the three-dimensional surface in relation to the entire network and therefore about its shape is obtained from the comparison of all network meshes with each other. These are available as numerical values and can be implemented in the two-dimensional map. This also allows the topographical information of the original surface to be mapped to its two-dimensional counterpart. Initially, the differences are only determined qualitatively. In order to be able to make more precise statements about the actual topographical properties of the original surface, the two networks have to fulfil further criteria. These have to be optimized before the comparison is made.

### 4.5 Network Optimization

As explained above, meshes are used to provide the mathematical and geometric description of curved surfaces. They form an approximation to the continuous surfaces as described by NURBS surfaces. This means, they are discrete representations of these curves. As such, they play a major role in architecture. The production of continuously curved surfaces is associated with enormous costs and is, from an engineering standpoint, extremely demanding. By sub-dividing these continuous surfaces into smaller polygonal elements, it is possible to deploy a more economical production method. This becomes particularly clear with, for example, the geodesic domes of Buckminster Fuller or the designs of V. G. Suchov. The surface is dispersed into bars in such a way that as many of the individual edges as possible have the same length and therefore can be manufactured in series production. The results are bar structures, but, in particular, also grid shells, in which the desired surface is formed by a network of bars. On account of the work on grid shells carried out by Frei Otto at the Institute for Lightweight Structures in Stuttgart (IL), the architectural variety of shapes that can be produced as truss structures was considerably extended as methods for their calculation and modelling were developed. The research at the IL initially aimed to develop methods for form finding. By observing natural structures, form-forming principles can be identified, which are analogously applied to the architectural scale. It is important to note here that this method of modelling applies entirely in analogy. The method itself is not based on evolutionary algorithms, but speculatively describes processes of shape formation in nature in order to apply these processes to different materials and utilize them under completely different conditions at the architectural scale. First of all, the aim was the search for form-forming processes which were evolutionary methods, that is, methods of form-finding as a result of form-optimization. From these observations, models were developed, with which these form-forming processes can be simulated. The insights from this have been combined in a subsequent step to form methods. The insights from this form a further approach in my project.¹¹

### 4.6 Shape Optimization—Networks as Models of Grid Shells

In particular, the studies on lattice shells have a direct influence on my way of model-making by means of auxetic structures.

Structurally, grid shells are nothing other than 3-dimensional networks, the edges of which are formed as bars and the corners of which are formed as nodes. They are, so to speak, the architectural form of meshes. For them, it is of great importance that they have a materiality. This means, on the one hand, that the forces have to be considered and, on the other hand, that the necessities of production have to be taken into account. The initial investigations on lattice shells aimed to use shape-finding processes for the determination of the spatial form associated with the network under a specific external load. For this purpose, physical, smaller-scale models (mostly chain models) are constructed and their hanging shape is determined photogrammetrically. [FIG. 2.13; FIG. 2.14] At the same time, the number of different bars within the grid or, better still, of different meshes within the network has to be minimized in order to make it possible to actually produce the structure at a later point. In view of this, at IL, model investigations are being carried out, in particular for networks with identical meshes, the shapes these can take and the flat projections associated with them. Methods for the modelling are developed and analogies are formed from the findings, which can then be applied to other shapes. In contrast to the digital structural optimization described below, during which the external shape is not modified, the form finding methods developed at the IL have a direct influence on the desired shape. It is only used as a starting point for the creation of an optimized variant. These optimizations change the form. Therefore, these are form optimizations.

### 4.7 Structure Optimization

In contrast to the physical methods of network optimization described above with their effects on the given shape, it is possible to optimize grids by means of digital methods of network optimization without any change to the shape of the surface. In contrast to the form optimisation described above, this is a structure optimisation. The form itself is not changed; however, the distribution of the grid on the form can change, for example, based on the force flow of the represented component.

One possible method to achieve this is dynamic relaxation. This is a “physical interpretation” of the mesh, which uses a system of mass points (corners) and springs (edges). Then some corners are fixed and the others are allowed to move freely until the system assumes an equilibrium position.”¹² By projecting the shifted points back onto the original surface, an iterative process results in an increasingly uniform mesh on the surface described! This form of network optimization is ultimately based on mathematical algorithms and it can be applied both to planar and three-dimensional networks. This means, that now a large number of tools are available, which allow the optimization or varying of the corresponding network pairs required for the process with regard to their relationship but also independently of each other. The optimization can be carried out with regard to many criteria at the same time. These are non-linear optimizations, which do not possess unambiguous best solutions but instead the search attempts to identify relative optima. This search makes use of evolutionary principles. Parameters are set and the weighted result is compared to other results. Taking account of the results, variants are produced by changing the starting parameters and the results generated in this way are compared again. The results of the continued iterative process are relative optima, which are represented by certain variations of the set parameters. “The widespread availability of NURBS modelling software currently allows designers, architects and sculptors to precisely create a huge range of different geometries. However, it is not always clear how to create an efficient gridshell structure to support a given freeform shape.”¹³

A further advantage of the digital optimization is the option to be able to integrate digital static calculation models for the architectural figure (for example, a grid shell), which for the optimization process is only represented by the mesh. This means that, in addition to the shape, also the dimensioning and the material properties can be taken into consideration. The force functions and stresses are calculated for a finite elements model (FE model). The structure of the given shape can be further matched and optimized in a further iterative process.

### 5.0 Auxetic Structures for Creation of Free-Form Surfaces

### 5.1 Modelling—Description of the Digital Experimental Set-Up

For the approximation to free-form surfaces by means of auxetic structures, two different patterns will be investigated here. One is based on a quadrangular grid, the other is based on a tetragonal distribution of the patterns. As described above, both the patterns have a different limit, up to which they can be stretched, which suggests that they are correspondingly better suited for different surface shapes.

[FIG. 2.15-18; FIG. 2.29; FIG. 2.39]

The starting points, for the investigation are arbitrary free-form surfaces. [FIG. 2.19] These are representative for free-form components, shell constructions or facing element.

The modification process starts by transferring the surfaces to a mesh in the form of its mathematical representation. [FIG. 2.20] This allows, on the one hand, the deployment of all of the options provided by digital network processing on the mathematical model for the figure and, on the other hand, it provides a network topography, in which the original area in the two-dimensional projection is determined and on the basis of which the auxetic structure is eventually formed. The network topology is therefore transferred to a two-dimensional plane. Both meshes can now be optimized independently of each other; only their network topology must no longer be changed. When the three-dimensional meshes are modified, this is one of the structural optimizations described above. The relative ratio of the mesh nodes with regard to each other is retained; however, the actual numerical distances can be varied in order to provide a higher density, e.g. at locations, which support higher loads or where the curvature of the surface is greater. Here, the various algorithmic methods for the grid shell optimization can be implemented into the model.¹⁴

### 5.2 Mapping of the Topology—Connection Between the Two-Dimensional Shape and the Three-Dimensional Structure

The decisive aspect of the model lies in the method for determining the relationship between the three-dimensional mesh and its two-dimensional projection. Depending on the surface class of the original figure, there are various options: for three-dimensional shapes with a fixed edge, a simple projection of the grid/mesh is used and a comparison mesh is created for the model to be formed. All modifications to the initially regular auxetic structure have to be able to be implemented within the unmovable edge of the pattern. In the case of three-dimensional shapes with one or several free edges, the idea seems obvious, to create the two-dimensional reference mesh by means of conformal mapping. In this case, the degree of freedom is much higher, so that the edge of the projected surface can be selected almost without restriction. Both processes end up with an edge curve and a subdivision of the created surface with a network topology, which is identical to that of the three-dimensional figure. This topological grid is deployed for the distribution of the pattern for the auxetic structure on the surface. [FIG. 2.12]

### 5.3 Mapping of the Topography—Comparison of the Areas

The comparison of the surface size of the network-topologically identical mesh surfaces of the shape and of the projected two-dimensional mesh surfaces is the key for the model development. [FIG. 2.21] The greater the difference is, the more the auxetic pattern has to be stretched at the corresponding point in the mesh, in order to be able to approach the original shape. In the converse argument, the following applies: if these two values do not differ, no stretch of the auxetic structure is required in order to reach the original shape—the two areas are already the same. This sets the lower limiting value.

From the comparison of all of the individual partial areas in the spatial mesh to the partial areas in the planar mesh it becomes obvious, which qualitative stretches are required in the individual meshes in order for the entire structure to be stretched sufficiently in space that it matches the original mesh.

The appearance of the auxetic structure with the two statuses “full stretchability” and “no stretchability” is known. [FIG. 2.15, 2.16 or FIG. 2.17, 2.18] All intermediate statuses can also be derived and described based on this. This allows a qualitative adaptation of the structure with the individual patterns of the auxetic structure to match the relevant qualitative differences in the areas.

In this way, an algorithmic method has been developed, by means of which the relative ratio of the areas directly controls the relative movement restriction of the auxetic structure by modification of the individual patterns.

### 5.4 Mapping of the Materiality—Implications of Static Properties

The process described above exclusively operates with the geometric context as it is expressed in mathematical functions. As such, the model is initially only a representation of the geometrical relationships but not a simulation of a material 3-dimensional figure. In order to achieve this, the results of the static analysis from the FE model can be implemented into the model at this point. The loads from the static model can be determined for any point on the surface. These points can be directly assigned to individual facets in the three-dimensional mesh. Similar to the method described above, the values for each facet of the three-dimensional figure can be assigned to the corresponding pattern on the two-dimensional mesh. In the next step, these qualitative values are implemented into the individual patterns of the auxetic structure. By means of the values obtained by comparing the areas, the cuts into the substrate creating the auxetic properties can be determined. In turn, the number of cuts determines the maximum local elongation as a consequence of the counter-rotating movement of neighbouring patterns around the joint (web) between them. By means of the values from the FE calculation, the joint widths can be controlled. The greater the forces are from the calculation of the area at any particular location, the wider the webs can be chosen in the relevant pattern within the auxetic figure. [FIG. 2.30] These joints are correspondingly harder to deform (because they take the form of plastic joints), but can absorb greater forces. In this way, the load determined in the simulation of the material properties can be directly implemented in the material auxetic structure. [FIG. 2.22, 2.23]

The planar mesh models the topological properties of the free-form surface!

The auxetic structure represents the topological and topographical features of the free-form surface!

The auxetic structure now also represents the material properties of the free-form surface!

### 5.5 Quantification as Evolutionary Optimisation

Up to this point in the programming, this is simply a qualitative transfer of the topological, topographical and material-specific properties of the free-form surface to the auxetic structure. Their relative ratios control the structure formation process. Once they are known, the connection between a three-dimensional free-form surface and its associated auxetic structure is described unambiguously. This means that the auxetic structures cannot be exactly transformed to the original shape. The correct quantitative solution can, however, not be determined unambiguously because the task cannot be formulated as a linear equation system. For this reason, it is necessary, once again, to make use of an iterative process, which allows the determination of an adequately precise solution by means of an evolutionary approach. Here, the same methods are used again as in the digital optimization, which have already been deployed earlier during the structural optimization.

### 5.5.1 The Auxetic Structure as a Spring Model

In the next step, the auxetic structure is changed by dynamic relaxation and the created surface is compared to the original surface. Now, form finding models deploying catenary curves developed at IL are virtually simulated within the digital process. It is assessed to which degree the “relaxed” auxetic structure approximates the original surface. [FIG. 2.13] Concretely, this means that the edges of the auxetic structure can be resolved into springs. At the nodes, the same forces are applied as in the FE model. These are external forces plus the dead loads of structure. The appropriate rigidities are allocated to the joints which, based on the results of the FE calculation, are of various thicknesses in order to be able to simulate varying plastic deformations at these points.

The relative ratio of the individual edges or spring lengths and relative rigidities of the plastic joints are directly obtained from the above evaluations. While the relative ratios between these values are maintained, their absolute values can now be parametrically varied. In this process, the two-dimensional auxetic structure is modified! In an iterative process, the individual values are repeatedly set and then the process of dynamic relaxation is started. [FIG. 2.24-2.26] After every cycle, the distance between the nodes compared to their location on the starting shape allows the assessment, to which degree the relaxed auxetic structure has approached the starting shape. [FIG. 2.27] The aim is to reach a configuration, in which the sum of all the distances is minimized. The setting of the individual parameters is a further evolutionary process.

At the end of this process, one or several versions of the auxetic structure remain, which best approach the original surface when the individual pattern is stretched to its maximum extension. [FIG. 2.28]

This means that, by means of this entirely digital model construction and processing chain, the modelling of structures, shapes and material properties of free-form surfaces on a two-dimensional structure has been achieved.

In the simplified process, these can easily be manufactured from isotropic plate materials—each one individually as a digital series!

### 6.0 Production and Application

The starting point of the investigation was the question how free-form components, which are the result of computer-aided design processes, can be produced in a simple way. The approach was to utilize the digital process chain as far as possible and to use the options offered by it to reduce the complexity of the actual physical implementation. In the present work, it has succeeded to model structure, shape and material properties of spatially curved surfaces in the form of irregular auxetic structures in a two-dimensional plane.

### 6.1 Manufacture of the Auxetic Structure

One way of manufacturing these structures is laser-cutting them from metal plates of appropriate thickness. To do this, the structural data obtained in the digital process can be directly transmitted to the machine tool. This laser-cutting method allows the manufacture of the created structures without further adjustments. Only with regard to the necessary strength of the joints, restrictions might become necessary, because the connecting webs must not fall below a certain width on account of the high temperatures arising when working with lasers. The technology for this method is tried and tested, but energy-intensive and, compared to other metal processing methods, rather time-consuming. For the same reason, the method of water jet cutting is not an alternative. It is much more economical to induce the auxetic properties into the material by punching. To do this, a simplification of the cut pattern would be necessary, i.e. a reduction in the number of cuts. The simplification can easily be integrated into the digital process; the variation range of potential cuts into the material can be created by cutting the same cut repeatedly while slightly moving the same tool. The aim has to be the simplification of the cuts in such a way, that the pattern can be punched by means of only four to six tools. In addition to a much increased speed of manufacture, this method also allows the manufacture of much bigger components.

In a further step, the two-dimensional auxetic structures will have to be transformed into their three-dimensional shape. A low-tech variant of this involves clamping them and covering them with a stretchable mat or two mats, which can be moved with regard to each other, and to weigh them down with, for example, sand until the stretch limit of the joints is exceeded and the entire structure is stepwise stretched into its target shape. This roughly corresponds to the dynamic relaxation in the digital model. One might also think of methods involving explosion forming. If, instead of steel sheet, a textile material is used, from which structures are laser-cut, the step of deformation by means of external forces can be largely omitted. One can also conceive of laser-cutting structures from carbon fibre or glass fibre fabrics. A further advantage is that, on account of the material properties of fabrics, there are nearly no limitations with regard to the size of the structures to be laser-cut. If several layers of laser-cut textile auxetic structures are stacked in order to join them together by means of a resin in order to fixating the “hanging shape”, small variations in the patterns in the different layer can control further properties. The individual layers can be orientated in different directions on the shape or the pattern in the structure can be informed by the structures of meshes with different network topologies. This can be done very easily within the digital process, using the methods of mesh optimization described above.

### 6.2 Facing Element

Both the two-dimensional and the three-dimensional deformed auxetic structures are aesthetically highly expressive. With the option of changing the external shape, the curvature and the variation of the patterns within the structure, they are ideal for the design of surfaces. If the cuts in the patterns are, for example, determined by means of a light simulation instead of a statics calculation, site-specific shading systems can be produced in this way.

Here, the advantage of being able to produce digital series with varying parameters can clearly be deployed with benefit.

### 6.3 Composite with Concrete

The auxetic structures that have been transformed to their three-dimensional shapes can, in conjunction with sprayed concrete, be used for the construction of greater components. Then, the size of the stretched openings in the auxetic structure is decisive. They have to be matched to the grain size of the sprayed concrete and its quality has, in turn, to be influenced by the forces to be transmitted.

In particular in conjunction with concrete as the second material, the stretched auxetic structure can fully unfold its potential. Weighing not even 10% of the total mass of the finished component, the entire shape of the structure can be reproduced by the structure. In this case, the structure simultaneously forms the formwork for the sprayed concrete applied using the Torkret process and provides the reinforcement. As described above, internal loads on the component can be directly implemented in the pattern. For larger loads or higher components of a greater thickness, multi-layered interconnected auxetic structures are also conceivable.

### 6.4 Outlook on Architecture

The described method will allow architects the simplified manufacture of the free-form structures they have created. In particular, the option to utilize the auxetic structures in conjunction with concrete as lost, form-defining formwork and reinforcements, provides the perspective that this method might be used for the construction of architecture, which otherwise would be impossible to build for cost reasons. Many of the mesh optimization processes described in the model are based on the wider context of the construction of shell structures. Such structurally optimized shell structures would be significantly different from their precursors of the 1960s and 1970s, which were created by form-finding processes that unavoidably required simplified formwork systems, but, at the same time, they would be resuming a tradition of shell construction, which for economic reasons seemed to have reached its end. This may potentially become a constructive task for the deployment of auxetic structures. But smaller free-form components are also conceivable, which, as a sequence in a serial variation, can provide their own design vocabulary for structuring space.

### 7.0 References

Adriaenssens, S. (2014). Shell structures for architecture: Form finding and optimization. London [inter alia]: Routledge.

Dechau, W., & Müther, U. (2000). Kühne Solitäre: Ulrich Müther—Schalenbaumeister der DDR. Stuttgart: Dt. Verl. -Anst

Greco, C., & Nervi, P. (2008). Pier Luigi Nervi: Von den ersten Patenten bis zur Ausstellungshalle in Turin; 1917-1948. Pier Luigi Nervi <German version>. Luzern: Quart-Verl.

Haupt, J., Kull, U., Otto, F., Helmcke, Johann-Gerhard, & Bach, Klaus. (1990). Schalen in Natur und Technik. 2. Radiolarien=Radiolaria=Shells in Nature and Technics, 320 p.; mostly III., graph. Representations

G'Helmcke, J. (2004). Schalen in Natur und Technik. 3. Diatomeen: 2=Shells in nature and technics. Stuttgart [inter alia]: Krämer.

Hennicke, J. (1974). Gitterschalen: Bericht über das japanisch-deutsche Forschungsprojekt S. T. T., carried out in the time from May 1971 to May 1973 at the Institut für Leichte Flächentragwerke (IL-Institute for Lightweight Structures), Stuttgart University=Grid shells. Stuttgart [inter alia]: Krämer [inter alia].

Knippers, J. (2010). Atlas Kunststoffe+Membranen: Werkstoffe und Halbzeuge, Formfindung und Konstruktion (1st edition). München: Inst. für Internat. Architektur-Dokumentation. [Institute for International Architecture Documentation]

Nerdinger, W., Barthel, R., & Krippner, R. (2010). Wendepunkte im Bauen: Von der seriellen zur digitalen Architektur; [on the occasion of the exhibition “Wendepunkt(e)im Bauen-Von der Seriellen zur Digitalen Architektur” in the Architecture Museum of the TU München at Pinakothek der Moderne, 18 Mar. to 13 Jun. 2010]. München: Detail, Inst.für Internat. Architekturdokumentation. [Institute for International Architecture Documentation]

Oliva Salinas, J. (1982). Über die Konstruktion von Gitterschalen. Stuttgart: Univ.

Otto, F. (1984). Form: Ein Vorschlag zur Entwicklung einer Methode zur Ordnung und Beschreibung von Formen. Stuttgart.

Otto, F., & Bach, K. (1984). Selbstbildung: Physikalische und konstruktive Entstehungsprozesse, die auf die Entstehung, Ausbildung und den Wandel organischer Objekte Einflufβ habenund die ouch für Technik und Architektur von Bedeutung sein können. Stuttgart: SFB 230.

Pauly M. et al. Beyond Developable:

Computational Design and Fabrication with Auxetic Materials

SIGGRAPH '16 Technical Paper, Jul. 24-28, 2016, Anaheim, Calif.,

ISBN: 978-1-4503-4279-7/16/07

Pottmann, H. (2010). Architekturgeometrie. Architectural geometry <German version>. Wien [inter alia]: Springer.

Schneider, M., & Nervi, P. (1989). Gestalten in Beton: Zum Werk von Pier Luigi Nervi. Cologne: R. Müller.

Stachowiak, H. (1973). Allgemeine Modelltheorie. Wien [inter alia]: Springer.

Stachowiak, H. (1983). Modelle—Konstruktion der Wirklichkeit. München: Fink.

On the Internet:

https://spacesymmetrystructure.wordpress.com

https://de.wikipedia.org/wiki/UV-Koordinaten

http://elise.de/

### Appendix 3

### Multi-Layered Auxetic Structures for Doubly-Curved Shapes

### Abstract

Appendix 3 presents the idea that multiple layers of auxetic structures can be combined to achieve synergetic effects relating to aesthetic and/or structural performance. We describe a novel approach of using auxetic structures to produce a wide range of doubly-curved target shapes with full control over the porosity, shape and distribution of the resultant polygonal openings at the end of the forming process. Our method of polygonal patterning makes it possible to control the transient aperture of the cut-outs for the purpose of aesthetic and structural optimization (e.g. for application as bespoke steel reinforcement for composite materials with complex geometries or in consumer products with particular aesthetic and curvature requirements).

We take Evans' [1] fundamental investigations on auxetic structures as a starting point. On a macroscopic scale, auxetic behaviour is obtained by making cuts in sheet materials or textiles according to a specific regular pattern. When stretched, this allows for lateral as well as spatial deformation as described by Konaković [2].

We have previously built on this to develop what we call irregular auxetic structures and shown their inherent ability to precisely describe the surface of arbitrary given double-curved surfaces [3]. We have now developed a digital process that not only calculates the corresponding 2D auxetic structures for a given surface, but also makes it possible to control the resulting 3D surface (pattern) and 3D structure (porosity, following the course of forces) of these spatially deformed, layered auxetic structures. Each of the corresponding layers is produced by inserting the calculated cuts and/or openings into flat sheet material (steel, textile). The flat layers are then pressed into the desired shape using a mold to build the required structure, and fixed together by using either resin (for textiles) or concrete (for steel). Hence our process also lays the ground for a new application of auxetic structures in molding processes. This paper details the computational methods developed to facilitate this novel class of auxetic structures and presents initial findings on the mechanical behavior of physical prototypes.

### Introduction

This paper describes a novel approach to producing initially non-developable shapes from flat structures. Building on the properties of auxetic structures, we introduce an innovative way of combining them in multiple layers. Our approach allows us to generate and coordinate the individual layers in such a way that the properties of the resulting spatial structures can be specifically designed to achieve synergetic effects relating to aesthetic and/or structural performance. Based on our previous research on creating doubly-curved surfaces from irregular auxetic structures [3], this paper is a preliminary investigation on the fundamental possibility of using multi-layered auxetic structures to create watertight shapes. We describe the digital pipeline leading to the generation of the structures and present first results.

### 1. Definition of Auxetic Behaviors

Auxetic behavior is a material property allowing for negative transverse stretching. It describes an atypical deformation behavior: auxetic materials expand when pulled and contract when compressed. This type of transverse strain is described with a negative Poisson number. As a side-effect, this provides the substantial advantage of being able to form them spatially into any bi-axially curved surface.

### 1.1. Auxetic Mechanism

Auxetic behavior is made possible by a specific cellular structure forming deformation mechanisms. Saxena [4] gives a thorough overview on the research on auxetics so far. Based on the specific mechanism, the auxetic cellular structures are classified into re-entrant type, chiral type and rotating units.

Our work focusses on rotating units. Here, auxetic behavior is obtained from the rotation of rigid polygons connected to each other through hinges.

It is the geometry of the structure that warrants kinematic movement, according to a given set of rules: adjacent faces always stay connected through one common vertice, around which they rotate according to an alternating clockwise/counter-clockwise pattern (similar to Hoberman's “reversibly expandable structures”, [5]). This rotation causes the structure to expand simultaneously as it is pulled.

A major advantage of the auxetic structures of the rotating-polygon type is that they can be easily manufactured at the macroscopic level. Through cuts in flat, nearly inextensible materials, perforations can be created that mimic the behavior of rotating polygons.

### 1.2. Spatial Deformability and Geometry of Incisions

A rotation around the common vertices leads to a lateral deformation. Yet the mechanism also allows for a spatial deformation. This makes it possible to deform flat auxetic structures so as to generate specific spatial shapes from them [2].

As we have seen, the auxetic behavior we are looking for is created by incisions in flat material made according to a specific pattern. Depending on the type of pattern, the structures have different extensibilities—expressed in a different Poisson number [1], [6].

There is a direct relationship between the deformability and the geometry of the cuts. Not only the incision pattern [7]-[11], but also the concrete shape of the incisions, the width of the angles, as well as the ratio of the edge lengths of the adjacent polygons all influence the deformability [12].

### 1.3 Irregular Auxetic Structures

The above mentioned variations of cut-outs can either be applied globally for the entire structure or vary locally, leading to respectively regular and irregular auxetic structures [3]. Irregular auxetic structures result in one specific spatial shape when fully stretched. Conversely it is therefore possible to calculate the specific irregular cut-outs forming the auxetic structure leading to this target shape in the fully stretched state [3].

### 2. Multi-Layered Auxetic Structures

The result of the stretching process is a porous planar or spatial matrix. For some applications however, it would be preferable to obtain watertight shapes.

Our previous investigations aimed at finding the one auxetic structure which would, in its fully stretched state (each incision being maximally stretched), result in a specific target shape. Our goal then was to create spatial structures starting from flat sheet materials—but without the help of formwork. The focus was on the use of steel sheets, which, when fully stretched, would serve as a kind of porous spatial matrix in combination with shotcrete. However with this approach, the range of resulting shapes as well as the control over the overlapping areas is rather limited.

The now proposed method of superimposing auxetic structures is aimed at producing watertight rather than porous shapes. This calls for a move away from sheet materials towards textile materials and membranes that are bonded together by resins through lamination. This lamination process necessarily requires individual formwork, which means that the production of the spatial shape no longer depends on one fully stretched auxetic structure. The freedom of design hence dramatically increases.

### 2.1 Corresponding Auxetic Structures

Our solution to this is to combine two or more corresponding auxetic structures by layering them. To do this, we need to design at least one further auxetic structure that exactly covers the holes of the spatially expanded primary structure—the superimposed individual layers match to create a watertight shape. Where the one structure has holes, the other structure would have to show rigid polygons. In the places where the first structure has polygons the other one could show openings. We call this a dual auxetic structure in reference to the dual mesh it is calculated from.

### 2.2 Generating the Dual Auxetic Structure

The first step in creating an auxetic structure corresponding to a specific spatial shape (FIG. 3.2a) is to discretize the surface of that shape (FIG. 3.2b). We convert it into a regular mesh, either triangular or quadrilateral, which forms the basis for the calculation of the auxetic structure. This is now our primal mesh. In geometry, polygons (including meshes) are associated into pairs called duals; for every primal mesh, there is a corresponding dual one. The duality means that the corners of one lie on the faces of the other and that the respective edges intersect at right angles. The special characteristic of the quadrilateral mesh is, as in our example, that the dual twin is also a quadrilateral mesh (FIG. 3.2c). Thus, this dual mesh can now be used as a basis for the calculation of a second corresponding auxetic structure—the dual auxetic structure.

As shown above, the auxetic structures of the rotating-polygons type follow a certain pattern. Certain corners remain connected. Slits or polygonal openings are cut out along the connecting edges.

Due to the basic definitions of the duality of the meshes described above, the incisions enabling the auxetic mechanism are now exactly above the faces of the other and vice versa.

However, depending on the configuration of the cuts (rather slits or closer to polygonal openings), overlaps in the incisions of both structures can occur—both in the relaxed and in the stretched state. The resulting overlay surface is therefore still partially porous. Only under carefully-defined conditions does the superposition of the two structures actually result in a watertight surface.

The necessary parameters can be determined by our digital pipeline. Here we draw on our findings on the spatial configuration of fully expanded irregular auxetic structures [3]. All incisions in the flat material are fully stretched (Poisson ratio 0) and show up as polygonal openings. Our digital process ensures that all stretched polygonal openings are always smaller than the corresponding rigid polygons of the dual structure, and are thus fully covered by them. The calculation for this is done exclusively in relation to the stretched state. From there we can determine (in effect retroactively) the necessary size and shape of the incisions in the flat structure.

It is only through the subsequent stretching of the structures that the incisions or polygonal openings widen so as to fit on the faces of the other structure. Both structures now complement each other to a watertight surface!

With the help of the dual mesh, it has been possible to generate two corresponding irregular auxetic structures that form a watertight surface in a stretched, spatial state. This lays the foundation for a completely new use of auxetic structures.

### 3. Hinges and Overlay

In a fully stretched state, the polygonal openings of one structure should in theory exactly (not more, not less) be covered by the closed polygons of the other—the shape would be watertight but with no overlaps. Of course, this is never the case in reality: due to the materiality of the hinges, there is necessarily going to be overlap. In these places the shape is in effect double-layered. There is a real advantage to purposefully designing these areas of overlap to further enhance our control over the structure of the three-dimensional shape.

### 3.1 Design of Structural Reinforcements

The exact nature of the overlap is directly related to the design of the corresponding auxetic structures. Geometric design and width of the hinges are mainly responsible for the resulting overlap. The design can be manipulated globally for all hinges (FIG. 3.6a) or locally for each individual hinge (FIG. 3.6c). The respective corresponding hinges of the two auxetic structures are designed in relation to each other. To facilitate the subsequent relaxation process, each hinge can be further discretized to allow for ever smoother bending and sheering [13].

The possibility of influencing the superimposition at any point in the structure gives the opportunity to specifically design the structural properties of the generated shape. This overlay (FIG. 3.6b,d) can serve as reinforcement, for example by following stress lines within the shape or by responding specifically to individual loads.

### 3.2 Design of the Surface Pattern

Due to the superimposition of two (or more) auxetic structures, a geometric pattern emerges on the surface in addition to the overlay—one at the top and one at the bottom. The design of the hinges has a significant influence on the type of pattern, too. Therefore it becomes possible to design the patterns on the surfaces of that shape by changing the individual hinges on each of the two corresponding auxetic structures, as well as the shape of the polygonal openings. Because we are not limited anymore to this one “fully stretched” state of the auxetic structure (through the use of formwork), the range of variations on offer is almost endless. Again, this can be advantageous for structural, but also for aesthetic reasons.

### 4. Generation and Physical Implementation

### 4.1 Digital Workflow

To create the auxetic structure associated with a spatial shape, we start by discretizing that shape. In a second step, we produce a conformal, two-dimensional map of the three-dimensional mesh. It has the same topology but is flat. It is helpful, but not necessary for the edge curves of the corresponding shapes to be identical. The conformal map serves as the basis for the construction of the flat auxetic structure. The variations of the incisions are determined through comparison of the corresponding edges and faces of both structures. The type and size of the hinges can also be controlled by parametrization, to follow for example main stress lines.

The stretching of the auxetic structure is simulated and tested within the given mold by means of a computational dynamic relaxation process. This process can be carried out in parallel for several auxetic structures, thus also simulating the overlay. An iterative optimization process will yield the desired result in a targeted manner.

### 4.2 Physical Workflow

First attempts were modelled with fabrics to sense-check our preliminary set-up, as a kind of physical proof of concept. The computed cuts were easily produced through lasering. Several such layers of two-dimensional auxetic structures out of fabric were then deformed in milled polystyrene molds by pressure and fixed by epoxy resin. This allowed us to confirm the workability of our multi-layered approach.

### 5. Applications and Further Steps

The illustrated method of generation and implementation of multi-layered auxetic structures is only in its infancy. The modeled digital workflow provides a basis for generating the corresponding auxetic structures. It also allows for the generation of the laser files and makes it possible to check the geometry obtained by means of dynamic relaxation. However, the inclusion of stresses in the calculations is so far only of a qualitative nature and will require thorough numerical evaluation.

Further steps will be to model the joints as plastic hinges, including further material-specific parameters. Depending on the simulated material, plastic deformations or sheering (for textiles) will also need to be taken into account.

It is to be noted that up to now, we have only focused our research on auxetic structures based on quadrilateral meshes. However these insights could also be transferred to other mesh topologies resulting in completely different types of auxetic structures.

As for practical applications, our approach is particularly suitable for the production of components with a highly complex shape like they abound in the automotive industry. So far, these special shapes have to be manufactured by putting together a large number of individual parts made of glass or carbon fiber, whereas just two layers of lasered auxetic structures could be sufficient!

### REFERENCES

[1] K. E. Evans, A. Alderson, Auxetic materials, “Functional materials and structures from lateral thinking!”, Advanced Materials 12(9), 617-628 (2000).

[2] M. Konaković, K. Crane, B. Deng, S. Bouaziz, D. Piker, M. Pauly, “Beyond developable: Computational design and fabrication with auxetic materials”, SIGGRAPH Technical Paper, Jul. 24-28 (2016).

[3] J. Friedrich, S. Pfeiffer, C. Gengnagel, “Locally varied auxetic structures for doubly-curved shapes”, In: Proceedings of the Design Modelling Symposium Paris 2017 323-336 (2017).

[4] K. K. Saxena, R. Das, E. P. Calius, “Three decades of auxetics research—Materials with negative Poisson's ratio: A review”, Advanced Engineering Materials, DOI: 10.1002/adem.201600053 (2016).

[5] C. Hoberman, “Reversibly expandable structures having polygon links”, U.S. Pat. No. 6,082,056 (2000).

[6] J. N. Grima, A. Alderson, K. E. Evans, “Negative Poisson's ratio from rotating rectangles”, Computational Methods in Science and Technology, 10(2), 137-145 (2004).

[7] J. N. Grima, L. Mizzi, K. M. Azzopardi, R. Gatt, “Auxetic perforated mechanical metamaterials with randomly oriented cuts”, Advanced Materials 28 (2), 385-389 (2016).

[8] J. N. Grima, K. Evans, “Auxetic behavior from rotating triangles”, Journal of Materials Science,

May 2006, 41, 3193.

[9] D. Attard, J. N. Grima, “Auxetic behaviour from rotating rhombi”, Phys. Status Solidi (b) 245, No. 11, 2395-2404 (2008).

[10] D. Attard, E. Manicaro, J. N. Grima, “On rotating rigid parallelograms and their potential for exhibiting auxetic behaviour”, Phys. Status Solidi (b) 246, No. 9, 2033-2044 (2009).

[11] J. N. Grima, E. Manicaro, D. Attard, “Auxetic behaviour from connected different-sized squares and rectangles”, Proceedings of the Royal Society, A 467(2121), 439-458 (2011).

[12] H. M. A. Kolken, A. A. Zadpoor, “Auxetic mechanical metamaterials”, RSC Adv., 2017,7, 5111-5129 (2017).

[13] M. Rabinovich, T. Hoffmann, O. Sorkine-Hornung, “Discrete Geodesic Nets for Modeling Developable Surfaces”, In: ACM Trans. Graph., 37(2) (2018).

1. An auxetic structure comprising material elements in a pattern with openings between the material elements, wherein the structure in a planar and/or non-planar position comprises at least one local variation from a regular pattern of the material elements and/or a regular pattern of the openings, so that when spatially deformed, at least some openings in the structure are locally stretchable into polygonal openings, free-from opening and/or openings with curved parts forming a spatial, grid-shaped pattern or a grid-shaped matrix.

2. The auxetic structure according to claim 1, wherein, the material elements are tessellate elements, sheet metal material elements, plastic or composite stretchable membrane, textile elements, a fiber composite material, wood element, plywood element and/or garment elements having at least locally different sizes and/or shapes.

3. The auxetic structure according to claim 1, wherein the openings are having locally different sizes and/or shapes.

4. The auxetic structure according to claim 1, wherein the mechanical strength of the connection between at least some of the material elements is adaptable to mechanical loads on the structure.

5. The auxetic structure according to claim 1, wherein the material elements have a triangular, rectangular, hexagonal, and/or polygonal shape, or a combination of those shapes.

6. the auxetic structure according to claim 5, wherein the triangular, rectangular, hexagonal and/or polygonal shapes of the material elements have identical side lengths.

7. The auxetic structure, according to claim 1, wherein the openings are cuts, incisions and/or polygonal.

8. The auxetic structure, according to claim 1, wherein the polygonal openings obtainable after the spatial deformation have a theoretic possible maximal size.

9. The auxetic structure according to claim 1, wherein an overall auxetic structure comprises at least two layers.

10. The auxetic structure according to claim 1, wherein an overall auxetic structure is composed of a plurality of smaller auxetic elements.

11. The auxetic structure according to claim 1, wherein the pattern of openings and/or material elements comprises at least one local variation from a regular pattern.

12. The auxetic structure according to claim 1, wherein an initial shape of the surface can be both planar and non-planar and when this surface is spatially deformed at least some openings in the structure are locally stretchable into polygonal openings, forming a spatial, grid-shaped pattern.

13. An auxetic composite comprising at least two layers of an auxetic structure according to claim 1.

14. (canceled)

15. (canceled)

16. A process for manufacturing an auxetic structure or auxetic composite structure, wherein
a) a deformable structure comprising material elements in a pattern with openings between the material elements, comprises at least one local variation from a regular pattern of the material elements and/or a regular pattern of the openings, is positioned in a flat position,
b) the deformable structure is spatially deformed, so that at least some openings in the structure are locally stretched into polygonal openings within a spatial, grid-shaped matrix.

17. The process according to claim 16, wherein concrete or resin is applied to the structure and then hardened.
